(19) United States
(12) Patent Application Publication
(10) Pub. No.: US 2025/0028207 A1
(43) Pub. Date: Jan. 23, 2025

(54) LIQUID CRYSTAL DISPLAY DEVICE

(71) Applicant: Sharp Display Technology Corporation, Kameyama City (JP)

(72) Inventors: Tsuyoshi OKAZAKI, Kameyama City (JP); Shinichi TERASHITA, Kameyama City (JP); Yuko TERAOKA, Kameyama City (JP); Kouichi WATANABE, Kameyama City (JP); Takehisa YOSHIDA, Kameyama City (JP); Yoshito HASHIMOTO, Kameyama City (JP)

(21) Appl. No.: 18/763,810

(22) Filed: Jul. 3, 2024

(30) Foreign Application Priority Data
Jul. 20, 2023 (JP) 2023-118315

(51) Int. Cl. G02F 1/1343; G02F 1/1333; G02F 1/1335; G02F 1/13363; G02F 1/137

(52) U.S. Cl. CPC G02F 1/134309; G02F 1/13338; G02F 1/133528; G02F 1/133638; G02F 1/13706

(57) ABSTRACT

A liquid crystal display device includes a first substrate, a second substrate, and a liquid crystal layer. The first substrate includes a reflective layer, a first electrode and a second electrode configured to generate a transverse electrical field in the liquid crystal layer, and a first horizontal alignment film. An electrode, of the first electrode and the second electrode, disposed on a side of the liquid crystal layer includes a plurality of belt-shaped portions and a slit positioned between two adjacent belt-shaped portions of the plurality of belt-shaped portions, the liquid crystal layer is constituted by a liquid crystal material including a liquid crystal molecule, the liquid crystal material is a positive type. The second substrate includes a second horizontal alignment film being in contact with the liquid crystal layer, and the liquid crystal layer takes a twist alignment when no voltage is applied.

### CROSS-REFERENCE TO RELATED APPLICATIONS

This application claims the benefit of priority to Japanese Patent Application Number 2023-118315 filed on Jul. 20, 2023. The entire contents of the above-identified application are hereby incorporated by reference.

### BACKGROUND

### Technical Field

The disclosure, which will be described below, relates to a liquid crystal display device.

Liquid crystal display devices, which utilize a liquid crystal material to function as a display device, are generally classified into transmissive liquid crystal display devices and reflective liquid crystal display devices depending on a display method. The transmissive liquid crystal display devices are devices that perform display in a transmission mode in which transmitted light from backlight on the back face of a screen is used, and the reflective liquid crystal display devices are devices that perform display in a reflection mode in which external light (also referred to as ambient light) instead of the backlight is used. For a display device having such characteristics, a transflective liquid crystal display device is proposed in which each pixel has a region for performing display in the transmission mode and a region for performing display in the reflection mode (see, for example, JP 2007-47734 A).

Liquid crystal display devices may be roughly classified according to a liquid crystal driving method, for example, a vertical electrical field mode liquid crystal display device in which a liquid crystal layer is driven by an electrical field in a direction substantially perpendicular to a substrate plane to perform display and a transverse electrical field type liquid crystal display device in which a liquid crystal layer is driven by an electrical field in a direction substantially parallel to a substrate plane to perform display are known. Examples of the vertical electrical field mode include a Twisted Nematic (TN) mode and a Multi-domain Vertical Alignment (MVA) mode, and examples of the transverse electrical field type include an In-Plane Switching (IPS) mode and a Fringe Field Switching (FFS) mode.

### SUMMARY

In recent years, liquid crystal display devices used in smartphones, tablets, and the like are usually provided with a touch sensor function. Various types of touch sensors are known, such as a resistive film type, an electrostatic capacitance type, and an optical type. A liquid crystal display device provided with a touch sensor (also referred to as a touch panel) is categorized into a type in which the touch sensor is externally attached (external type) and a type in which the touch sensor is built in (built-in type). The built-in touch panel is more advantageous than the external type touch panel in terms of frame narrowing, thickness in body, light weight, and the like, and also has an advantage in that the light transmittance can be increased.

There are two types of built-in touch panels: on-cell types and in-cell types. The cell means a display panel (also referred to as a liquid crystal panel) including an active matrix substrate represented by a Thin Film Transistor (TFT) substrate, a counter substrate disposed so as to face the substrate, and a liquid crystal layer held between the substrates. In general, in the in-cell type, a layer having a touch sensor function is disposed in the display panel, while in the on-cell type, the layer having a touch sensor function is disposed between the display panel and a polarizer provided on an observation face side of the display panel. In particular, the in-cell type can in principle achieve the thinnest and lightest touch panel. Additionally, a liquid crystal display device capable of performing display in the reflection mode is suitable for outdoor use, and thus, there is a need for in-cell type touch panels capable of performing display in the reflection mode. However, such touch panels are not achieved yet.

A reason why such a touch panel is not achieved yet is thought to be due to the fact that in current reflective liquid crystal display devices, one of a pair of electrodes (also called a counter electrode or a common electrode) for applying a voltage to the liquid crystal layer is placed on the counter substrate side. In view of the above, the present inventors consider that since both of a pair of electrodes are provided only on an active matrix substrate side for a transverse electrical field type such as an FFS mode, an in-cell type touch panel capable of performing display in a reflection mode can be achieved.

Thus, for example, an FFS mode device that performs display in a normally black mode is further studied. However, it is found that in such a device, although display in a reflection mode is possible, when a positive type liquid crystal material is used in the liquid crystal layer, a high reflectivity cannot be obtained particularly in white display in some cases, and when a negative type liquid crystal material is used, a high reflectivity can be obtained in white display but it is difficult to reduce a voltage (see a verification example, which will be described later). In addition, in recent years, there is a demand for lower power consumption due to an increase in needs for downsizing and cost reduction of display devices. Thus, it is ideal if display can be performed with a low voltage and a high reflectivity, but such a device is not achieved yet.

JP 2007-47734 A describes that when a twist alignment occurs in the reflective display region, a reflectivity in black display is equal to or less than 1% by setting a twist angle within a range equal to or more than 0° and equal to or less than 730 and adjusting the product of a cell thickness and a difference in refractive index of the liquid crystal layer within a range from 140 nm to 261 nm. However, there is no mention of the reflectivity in white display (also referred to as white reflectivity) or a method for further increasing the white reflectivity, and thus, high contrast cannot be expected. Regarding physical properties of the liquid crystal, only Δn=0.1 and Δε=11.3 are specified, and a relationship with the white reflectivity is not examined at all.

The disclosure has been made in view of the above-mentioned current situation, and an object thereof is to provide a liquid crystal display device that is capable of achieving a high reflectivity with a low voltage, and achieving high contrast and that is also useful as an in-cell type touch panel capable of performing display in a reflection mode, for example.

(1) According to an embodiment of the disclosure, a liquid crystal display device including a plurality of pixels, the liquid crystal display device including a first substrate, a second substrate facing the first substrate, and a liquid crystal layer provided between the first substrate and the second substrate, wherein the first substrate includes a reflective layer configured to reflect light, a first electrode and a second electrode configured to generate a transverse electrical field in the liquid crystal layer, and a first horizontal alignment film being in contact with the liquid crystal layer, an electrode, of the first electrode and the second electrode, disposed on a side of the liquid crystal layer includes a plurality of belt-shaped portions and a slit positioned between two adjacent belt-shaped portions of the plurality of belt-shaped portions, each of the plurality of belt-shaped portions has a linear shape extending substantially parallel to each other and in an identical direction, the liquid crystal layer is constituted by a liquid crystal material including a liquid crystal molecule, the liquid crystal material is a positive type, the second substrate includes a second horizontal alignment film being in contact with the liquid crystal layer, the liquid crystal layer takes a twist alignment when no voltage is applied, and a twist angle is equal to or more than 78° and equal to or less than 90° when no voltage is applied, the extending direction of the plurality of belt-shaped portions is positioned between a long axis direction of a liquid crystal molecule, of a plurality of the liquid crystal molecules, on a side of the first substrate and a long axis direction of a liquid crystal molecule, of the plurality of liquid crystal molecules, on a side of the second substrate at least in a central portion of the liquid crystal layer in a plane direction in a plan view of the liquid crystal layer of each of the plurality of pixels when no voltage is applied, and when a voltage is applied, at least a liquid crystal molecule, of the plurality of liquid crystal molecules, positioned in a central portion of the liquid crystal layer in a thickness direction is rotated, in a twist direction when no voltage is applied, in the plan view of the liquid crystal layer of each of the plurality of pixels.

(2) Further, in the liquid crystal display device according to an embodiment of the disclosure, in addition to the configuration (1) described above, a product (dΔn) of a thickness d of the liquid crystal layer and a birefringence index Δn of the liquid crystal material is equal to or more than 236 nm and equal to or less than 252 nm.

(3) Further, in the liquid crystal display device according to an embodiment of the disclosure, in addition to the configuration of (1) or (2) described above, a twist angle of the liquid crystal layer is equal to or more than 83° and equal to or less than 87° when no voltage is applied.

(4) Further, in the liquid crystal display device according to an embodiment of the disclosure, in addition to the configuration of (1), (2), or (3) described above, an average azimuth angle φLCave of the liquid crystal molecule is equal to or more than 150° and equal to or less than 156° when a voltage is applied.

(5) Further, in the liquid crystal display device according to an embodiment of the disclosure, in addition to the configuration (1), (2), (3) or (4) described above, the liquid crystal material has a ratio (Δn₆₀/Δn₂₀) of a birefringence index Δn₆₀ at 60° C. to a birefringence index Δn₂₀ at 20° C. being equal to or more than 0.84.

(6) Further, in the liquid crystal display device according to an embodiment of the disclosure, in addition to the configuration of (1), (2), (3), (4), or (5) described above, the liquid crystal material has an anisotropy of dielectric constant Δε being equal to or lower than 7.

(7) Further, in the liquid crystal display device according to an embodiment of the disclosure, in addition to the configuration of (1), (2), (3), (4), (5), or (6) described above, a polarizer disposed outside the first substrate and/or the second substrate, and a phase difference layer disposed between the first substrate and the polarizer and/or between the second substrate and the polarizer, are further provided, and the phase difference layer includes λ/4 plate and λ/2 plate.

(8) Further, in the liquid crystal display device according to an embodiment of the disclosure, in addition to the configuration of (1), (2), (3), (4), (5), (6), or (7) described above, the liquid crystal display device has a single domain alignment.

(9) Further, in the liquid crystal display device according to an embodiment of the disclosure, in addition to the configuration of (1), (2), (3), (4), (5), (6), (7), or (8) described above, display is performed in a normally black mode.

(10) Further, in the liquid crystal display device according to an embodiment of the disclosure, in addition to the configuration of (1), (2), (3), (4), (5), (6), (7), (8), or (9) described above, one of the first electrode and the second electrode is a pixel electrode provided in each of the plurality of pixels and the other is a common electrode including a plurality of segments each of which is configured to function as a touch sensor electrode, and the first substrate includes a plurality of touch wiring lines each of which is connected to a corresponding one of a plurality of the touch sensor electrodes.

(11) Further, in the liquid crystal display device according to an embodiment of the disclosure, in addition to the configuration of (1), (2), (3), (4), (5), (6), (7), (8), (9), or (10) described above, a light source is further provided.

According to the disclosure, it is possible to provide a liquid crystal display device that is capable of achieving a high reflectivity with a low voltage, and achieving high contrast and that is also useful as an in-cell type touch panel capable of performing display in a reflection mode, for example.

### BRIEF DESCRIPTION OF DRAWINGS

The disclosure will be described with reference to the accompanying drawings, wherein like numbers reference like elements.

FIG. 1 is a schematic cross-sectional view of a liquid crystal display device 1.

FIG. 2 is a schematic cross-sectional view more specifically illustrating the liquid crystal display device 1.

FIG. 3 is a schematic plan view of the entire liquid crystal display device 1 viewed from an observation face side.

FIG. 4 is a diagram for describing definition of an angle.

FIG. 5 is a schematic plan view schematically illustrating one pixel.

FIG. 6 is an enlarged schematic plan view of a part of FIG. 5.

FIG. 7 is a liquid crystal director distribution diagram (cross-sectional view).

FIG. 8A is an enlarged schematic plan view of a part of FIG. 5.

FIG. 8B is a liquid crystal director distribution diagram (cross-sectional view).

FIG. 9A is an enlarged schematic plan view of a part of FIG. 5.

FIG. 9B is a liquid crystal director distribution diagram (cross-sectional view).

FIG. 10A is an enlarged schematic plan view of a part of FIG. 5.

FIG. 10B is a liquid crystal director distribution diagram (cross-sectional view).

FIG. 11A is an enlarged schematic plan view of a part of FIG. 5.

FIG. 11B is a liquid crystal director distribution diagram (cross-sectional view).

FIG. 12A is a diagram illustrating a calculation model of a liquid crystal director distribution diagram.

FIG. 12B is a diagram illustrating a calculation example of a VR curve.

FIG. 12C is a liquid crystal director distribution diagram (cross-sectional view).

FIG. 13A is a schematic cross-sectional view taken along a line A-A′ in FIG. 5 (a line A-A′ cross-sectional view) and conceptually illustrating a behavior of liquid crystal molecules 21 when no voltage is applied.

FIG. 13B is an enlarged schematic plan view of a part of FIG. 5 and conceptually illustrates a twist direction of the liquid crystal molecules 21 when no voltage is applied.

FIG. 14A is a schematic cross-sectional view taken along the line A-A′ in FIG. 5 (a line A-A′ cross-sectional view) and conceptually illustrates a behavior of the liquid crystal molecules 21 when a voltage is applied.

FIG. 14B is an enlarged schematic plan view of a part of FIG. 5 and conceptually illustrates a twist direction of the liquid crystal molecules 21 when a voltage is applied.

FIG. 15 is a schematic plan view illustrating, as an example, an arrangement relationship between touch sensor electrodes TX and touch wiring lines TL included in the liquid crystal display device 1.

FIG. 16 is a schematic cross-sectional view more specifically illustrating the liquid crystal display device 1.

FIG. 17 is a schematic cross-sectional view of the liquid crystal display device 1.

FIG. 18 is a schematic cross-sectional view more specifically illustrating the liquid crystal display device 1.

FIG. 19 is a plan view for describing an axis angle of each of optical films in the liquid crystal display device 1 including a first substrate 10, a liquid crystal layer 20, a second substrate 30, a λ/4 plate 41, a λ/2 plate 42, and a polarizer 50 in order from a back face side.

FIG. 20A is a conceptual diagram for describing a principle of performing black display.

FIG. 20B is a conceptual diagram for describing a principle of performing white display.

FIG. 21 is a schematic cross-sectional view more specifically illustrating the liquid crystal display device 1.

FIG. 22 is a schematic cross-sectional view of the liquid crystal display device 1.

FIG. 23 is a schematic plan view conceptually illustrating that each of pixels P includes a reflective region Rf and a transmissive region Tr in the liquid crystal display device 1.

FIG. 24 is a schematic cross-sectional view of the liquid crystal display device 1.

FIG. 25 is a schematic cross-sectional view of the liquid crystal display device 1.

FIG. 26 is a graph illustrating reflection mode efficiency when each of liquid crystal materials is used.

FIG. 27 is a diagram obtained by analyzing VR curves illustrated in FIG. 26.

FIG. 28 is a reflectivity profile (cross-sectional view) at VRmax.

FIG. 29 is an analysis result of an average azimuth angle φLCave of liquid crystal molecules in a Z direction.

FIG. 30 is a graph in which VR curves of Example 2-6 are added to the graph of FIG. 26.

FIG. 31 is a graph obtained by examining temperature characteristics of Δn of various liquid crystal materials.

FIG. 32 is a graph obtained by examining temperature dependence of contrast.

FIG. 33 is a graph obtained by examining temperature dependence of reflection mode efficiency in black display.

FIG. 34 is a graph obtained by examining temperature dependence of reflection mode efficiency in white display.

### DESCRIPTION OF EMBODIMENTS

### Definition of Terms

In the present specification, an observation face side means a side closer to a screen (display surface) of a liquid crystal display device, and a back face side means a side farther from the screen (display surface) of the liquid crystal display device.

A voltage non-applied state means a state in which a voltage applied to a liquid crystal layer is less than a threshold voltage (including no voltage application). A voltage applied state means a state in which a voltage applied to the liquid crystal layer is a threshold voltage or higher. In the present specification, the voltage non-applied state is also referred to as “when no voltage is applied”, and the voltage applied state is also referred to as “when a voltage is applied”.

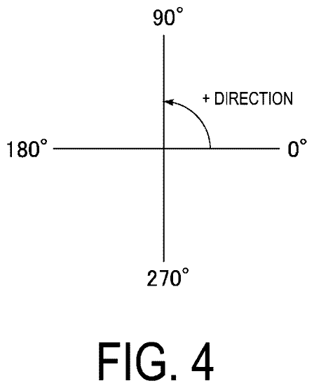

A polar angle means an angle formed between a subject direction (for example, a measurement direction) and a normal direction of the screen of the liquid crystal panel. An azimuthal direction means a direction when the subject direction is projected onto the screen of the liquid crystal panel, and is expressed by an angle (azimuth angle) formed between the subject direction and a reference azimuthal direction. Here, the reference azimuthal direction (0°) is set to a horizontal right direction of the screen of the liquid crystal panel. In the angle and the azimuth angle, a positive angle is counterclockwise from the reference azimuthal direction, and a negative angle is clockwise from the reference azimuthal direction (see FIG. 4). FIG. 4 is a diagram for describing definition of an angle. Counterclockwise and clockwise both represent the rotation direction when the screen of the liquid crystal panel is viewed from the observation face side (front). The angle represents a value measured when the screen of the liquid crystal panel is viewed in a plan view.

An axial azimuthal direction of the optical film means an azimuthal direction of a polarization axis of a polarizer in a case of the polarizer, and means an azimuthal direction of a slow axis in a case of a phase difference layer. The polarization axis of the polarizer means an absorption axis in a case of an absorption-type polarizer, and means a reflection axis in a case of a reflection-type polarizer. The axial azimuthal direction of the phase difference layer means an azimuthal direction of an in-plane slow axis of the phase difference layer unless otherwise specified.

The phase difference layer means a layer in which at least one of an in-plane retardation (also referred to as an in-plane phase difference) Re or a thickness direction retardation (also referred to as a thickness direction phase difference) Rth has a value equal to or more than 10 nm. Preferably, the phase difference layer has a value equal to or more than 20 nm. It should be noted that numerical values described herein as Re and Rth are absolute values unless otherwise specified.

The in-plane phase difference Re is defined as Re=(nx−ny)×d.

The thickness direction phase difference Rth is defined as Rth={nz−(nx+nyλ/2}×d.
nx represents a principal refractive index in an in-plane slow axis direction of each phase difference layer.
ny represents a principal refractive index in an in-plane fast axis direction of each phase difference layer.
nz represents a principal refractive index in a direction perpendicular to a plane of each phase difference layer.

The slow axis direction is an azimuthal direction in which the refractive index is maximized, and the fast axis direction is an azimuthal direction in which the refractive index is minimized. d represents a thickness of the phase difference layer.

An A plate is a phase difference plate satisfying “nx>ny≈nz”.

A measurement wavelength for an optical parameter such as a refractive index and a phase difference is 550 nm unless otherwise specified.

Being substantially parallel means that an angle (absolute value) formed between two lines is within a range of 0°±10°, and such an angle is preferably within a range of 0° 5°, and more preferably 0° (that is, being parallel in a narrow sense is meant). Being substantially orthogonal (or being substantially perpendicular) means that an angle (absolute value) formed between two lines is within a range of 90°±10°, preferably within a range of 90±5°, and more preferably 900 (that is, being orthogonal or perpendicular in a narrow sense is meant).

A liquid crystal display device according to embodiments of the disclosure will be described below. The disclosure is not limited to the contents described in the following embodiments, and design changes can be made as appropriate within the scope that satisfies the configuration of the disclosure.

### First Embodiment

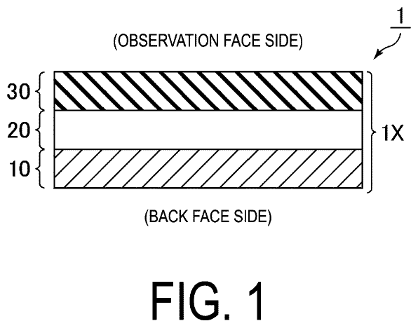

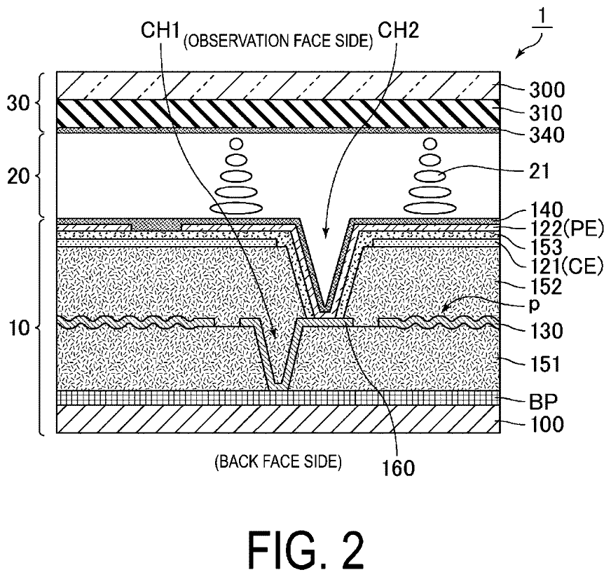

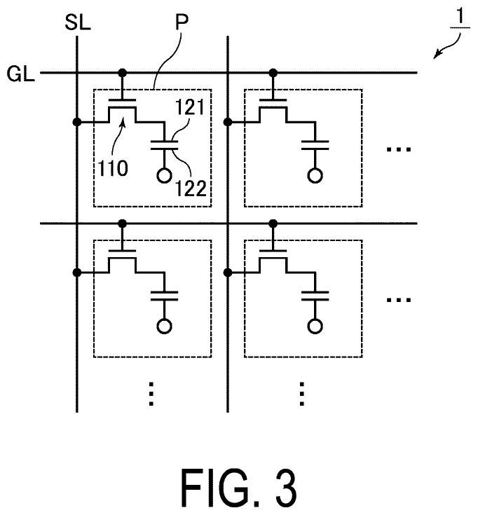

FIG. 1 is a schematic cross-sectional view of a liquid crystal display device 1 according to a present embodiment, and FIG. 2 is a schematic cross-sectional view more specifically illustrating the liquid crystal display device 1 according to the present embodiment. FIG. 3 is a schematic plan view obtained when a whole of the liquid crystal display device 1 according to the present embodiment is viewed from an observation face side. As illustrated in FIG. 1, the liquid crystal display device 1 includes a first substrate 10, a liquid crystal layer 20, and a second substrate 30, in order from the back face side. In the present embodiment, a TFT substrate is used as the first substrate 10. Note that a portion or a structural body including a structure in which the liquid crystal layer 20 is interposed between the first substrate 10 and the second substrate 30 is also referred to as a liquid crystal panel 1X.

The liquid crystal display device 1 includes a plurality of pixels P arrayed in a matrix shape, as illustrated in FIG. 3. Although the plurality of pixels P typically include three types of pixels, that is, a red pixel, a green pixel, and a blue pixel, the number of types of pixels may be two or less or four or greater. Each pixel P includes a Thin Film Transistor (TFT) 110 and a first electrode 121 and a second electrode 122 that may generate a transverse electrical field in the liquid crystal layer 20. A gate electrode of the TFT 110 is electrically connected to a corresponding gate wiring line (also referred to as a scanning wiring line) GL, and a source electrode of the TFT 110 is electrically connected to a corresponding source wiring line (also referred to as a signal wiring line) SL. A drain electrode of the TFT 110 is electrically connected to the second electrode 122.

### First Substrate

As illustrated in FIG. 2, the first substrate 10 includes a reflective layer 130 that reflects light, the first electrode 121, the second electrode 122, and a first horizontal alignment film 140 in contact with the liquid crystal layer 20 in order from the back face side to the observation face side. It is preferable that the first substrate 10 further include a support substrate 100 and a backplane circuit BP on the back face side of the reflective layer 130. If necessary, an insulating layer (also referred to as an insulating film) is provided between the layers and the like. For example, a first interlayer insulating layer 151 is provided so as to cover the backplane circuit BP, a second interlayer insulating layer 152 is provided on the first interlayer insulating layer 151 with a reflective layer 130 interposed therebetween, and a dielectric layer (also referred to as a third interlayer insulating layer) 153 is provided between the first electrode 121 and the second electrode 122.

The support substrate 100 is preferably transparent and has an insulating property, and examples of the support substrate 100 include a glass substrate and a plastic substrate.

The backplane circuit BP is provided on the support substrate 100. The backplane circuit BP is a circuit for driving the plurality of pixels P, and includes the TFT 110, gate wiring lines GL and source wiring lines SL. Note that usually, the backplane circuit BP also includes a gate insulating film.

The TFT 110 is provided in each of the plurality of pixels P. Each TFT 110 suitably includes an oxide semiconductor layer as an active layer (and is also referred to as an oxide semiconductor TFT). Specifically, the oxide semiconductor layer suitably includes at least one metal element among In (indium), Ga (gallium), or Zn (zinc). In particular, an oxide semiconductor film including a ternary oxide of In, Ga, and Zn is more preferable. A preferable example of the ternary oxide of In, Ga, and Zn is indium gallium zinc oxide. A semiconductor including a ternary oxide of In, Ga, and Zn is called an In—Ga—Zn—O-based semiconductor, but in such a semiconductor, a proportion (composition ratio) of In, Ga, and Zn is not particularly limited, and for example, In:Ga:Zn=2:2:1, In:Ga:Zn=1:1:1, In:Ga:Zn=1:1:2, and the like may be adopted. The In—Ga—Zn—O-based semiconductor may be amorphous or crystalline. In the crystalline In—Ga—Zn—O-based semiconductor, a c-axis is suitably oriented approximately perpendicular to a layer plane.

The first interlayer insulating layer 151 is provided so as to cover the backplane circuit BP. A surface of the first interlayer insulating layer 151 on a reflective layer 130 side preferably has an uneven shape (also referred to as an uneven surface structure). Accordingly, the reflective layer 130 is capable of having an uneven surface structure reflecting such an uneven shape. The first interlayer insulating layer 151 having an uneven surface structure may be suitably formed by using a photosensitive resin, for example, as described in JP 3394926 B.

The reflective layer (also referred to as a reflective film) 130 is provided on the first interlayer insulating layer 151. The reflective layer 130 is formed of a material that reflects light. In particular, the reflective layer is preferably formed of a metal material having high reflectivity. Examples of the material of the reflective layer 130 include a silver alloy and an aluminum alloy.

The reflective layer 130 preferably has an uneven shape reflecting the uneven surface structure preferably provided in the first interlayer insulating layer 151. That is, the reflective layer 130 also suitably has the uneven surface structure. Such an uneven surface structure is also called Micro Reflective Structure (MRS), and is provided to diffusely reflect ambient light and achieve white display close to paper white. The uneven surface structure is preferably configured of a plurality of protruding portions p randomly arranged, for example, such that a center interval between the adjacent protruding portions p is equal to or more than 5 μm and equal to or less than 50 μm. The center interval between the adjacent protruding portions p is more preferably equal to or more than 10 μm and equal to or less than 20 μm. Suitably, a shape of each protruding portion p is substantially circular or substantially polygonal when viewed from a normal direction of the support substrate. An area of the protruding portion p occupying one pixel P is preferably about from 20% to 40%, for example, and a height of the protruding portion p is preferably equal to or more than 1 μm and equal to or less than 5 μm, for example.

The second interlayer insulating layer 152 is provided on the first interlayer insulating layer 151 so as to cover the reflective layer 130. That is, between the first interlayer insulating layer 151 and the second interlayer insulating layer 152, the reflective layer 130 is disposed.

Here, the first interlayer insulating layer 151 and the second interlayer insulating layer 152 are preferably formed of an organic insulating material or an inorganic insulating material. Examples of the organic insulating film obtained by using the organic insulating material include an organic film (relative dielectric constant ε=2 to 5) such as an acrylic resin, a polyimide resin, and a novolac resin, and layered bodies thereof. A film thickness of the organic insulating film is not particularly limited, but is equal to or more than 2 μm and equal to or less than 4 μm, for example. Examples of the inorganic insulating films obtained by using the inorganic insulating material include an inorganic film (relative dielectric constant ε=5 to 7) such as silicon nitride (SiNx) and silicon oxide (SiO₂), and a layered film thereof. A film thickness of the inorganic insulating film is not particularly limited, but is equal to or more than 1500 Å and equal to or less than 3500 Å, for example. Alternatively, a layered body of the organic insulating film and the inorganic insulating film may be used. In particular, the first interlayer insulating layer 151 and the second interlayer insulating layer 152 are suitably an organic insulating film.

A thickness of each interlayer insulating layer is not limited, but is preferably, for example, from 0.2 μm to 0.5 μm.

The first electrode 121 is disposed on the reflective layer 130 with the second interlayer insulating layer 152 interposed therebetween, and the dielectric layer 153 is disposed between the first electrode 121 and the second electrode 122. Therefore, the reflective layer 130 is located on a side opposite to the liquid crystal layer 20 with respect to the first electrode 121 and the second electrode 122 (that is, on a side closer to the back face side with respect to the first electrode 121 and the second electrode 122). Note that of the first electrode 121 and the second electrode 122, in the present embodiment, the second electrode 122 is located relatively on the observation face side, and the first electrode 121 is located on the back face side. An electrode located relatively on the observation face side is also referred to as an upper layer electrode, and an electrode located relatively on the back face side is also referred to as a lower layer electrode.

One of the first electrode 121 and the second electrode 122 is a pixel electrode PE, and the other is a common electrode CE. The pixel electrode is provided for each of the plurality of pixels P. The pixel electrode is electrically connected to the backplane circuit BP. In the present embodiment, the first electrode 121 (lower layer electrode) is the common electrode CE, and the second electrode 122 (upper layer electrode) is the pixel electrode PE.

At least one of the first electrode 121 or the second electrode 122 includes a plurality of belt-shaped portions SP and a slit S1 located between two adjacent belt-shaped portions of the plurality of belt-shaped portions. Each belt-shaped portion SP corresponds to an electrode portion, and the slit S1 corresponds to an opening portion. Such an electrode is also referred to as a slit electrode or a finger electrode. From the viewpoint of easily generating a transverse electrical field, it is suitable that at least the upper layer electrode (pixel electrode PE in the present embodiment) is a slit electrode. In such a case, it is suitable that the lower layer electrode (common electrode CE in the present embodiment) is a planar electrode, that is, a so-called solid electrode.

Therefore, the plurality of belt-shaped portions SP configuring the slit electrode have a linear shape extending substantially parallel to each other and in the same direction. As a result, the alignment of the liquid crystal molecules is uniform and occurrence of alignment disorder is sufficiently suppressed. The linear shape means that not an outer edge of the belt-shaped portion SP but a center line of the belt-shaped portion SP has a linear shape, and the center line of the belt-shaped portion SP means a line bisecting the belt-shaped portion SP in a width direction. The width direction means a direction substantially perpendicular to a direction in which the belt-shaped portions SP extend in a plan view. Note that the belt-shaped portion SP may include a bent portion (also referred to as a kink portion) in the middle (for example, an end portion) thereof, but preferably does not include the bent portion.

In each pixel P, directions in which the plurality of belt-shaped portions SP extend (also referred to as an extending direction of the plurality of belt-shaped portions SP) are substantially parallel to each other. The extending directions of the plurality of belt-shaped portions SP may be different for each pixel, but are preferably the same in two or more adjacent pixels. In particular, it is more preferable that the extending directions of the plurality of belt-shaped portions SP be the same in at least the adjacent pixels from the viewpoint of manufacturing. It is more suitable that the extending directions of the plurality of belt-shaped portions SP are the same in a display region.

A width L of each belt-shaped portion SP is different depending on an applied voltage or the like, but is preferably from 0.3 μm to 10 μm, for example. More preferably, the width is from 1 μm to 5 μm. An interval between the two belt-shaped portions SP adjacent to each other (that is, an interval between the center lines of the respective belt-shaped portions) is also different depending on the applied voltage or the like, but is preferably from 0.3 μm to 10 μm, for example. More preferably, the interval is from 1 μm to 5 μm.

A ratio L/S (also referred to as an L/S condition) of the width L per belt-shaped portion in a plan view relative to a width S per slit in a plan view is preferably from 0.4 to 0.7/1. Accordingly, a reflectivity is further improved, and thus, a contrast ratio is further improved.

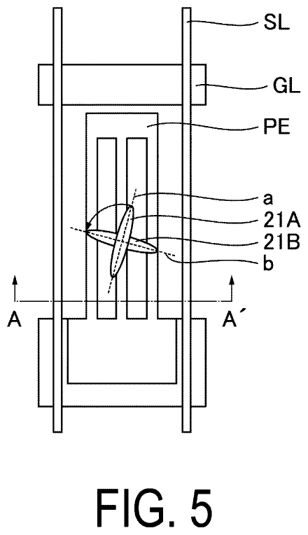

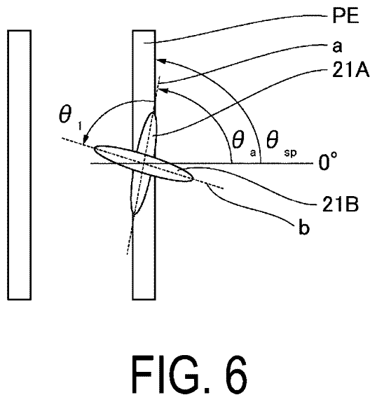

FIG. 5 is a schematic plan view schematically illustrating one pixel. FIG. 6 is an enlarged schematic plan view of a part of FIG. 5. In FIG. 5 and FIG. 6, a configuration in which the extending direction of the plurality of belt-shaped portions SP constituting the slit electrode (the pixel electrode PE in the present embodiment) is arranged in parallel with a plurality of source wiring lines SL, and a plurality of gate wiring lines GL are arranged so as to be orthogonal to the plurality of source wiring lines SL is illustrated as a schematic plan view. When a direction parallel to the gate wiring lines GL (horizontal direction in the drawings) is set as a reference (0°), and a clockwise rotation angle is set as a positive angle (+), and a counterclockwise rotation angle is set as a negative angle (−), the extending direction of the plurality of belt-shaped portions SP is positioned in a direction of 90θ (see also FIG. 4). This angle, that is, the angle of the extending direction of the plurality of belt-shaped portions SP when the direction parallel to the gate wiring lines GL is set as the reference (0°) is referred to as a slit angle θ_{SP}.

A suitable range of the slit angle θ_{SP} varies depending on conditions of the width L of each belt-shaped portion SP and the width S of each slit S1 (also referred to as an L/S condition), a twist angle, various physical properties of the liquid crystal material, but is preferably equal to or more than 30°, for example. The range is more preferably equal to or more than 60°, and still more preferably equal to or more than 80°. Additionally, an upper limit of the range is preferably equal to or less than 150°. The upper limit is more preferably equal to or less than 120°, and still more preferably equal to or less than 100°.

Each of the first electrode 121 and the second electrode 122 is preferably formed of a transparent conductive material. Examples of the transparent conductive material include Indium Tin Oxide (ITO), Indium Zinc Oxide (IZO (registered trademark)), and a mixture thereof.

In an aspect illustrated in FIG. 2, the pixel electrode PE (second electrode 122 in the present embodiment) is electrically connected to the backplane circuit (more specifically, to a drain electrode of the TFT 110) via a contact electrode 160. The contact electrode 160 is formed in the same layer as the reflective layer 130, and is formed of the same material (metal film and the like) as the reflective layer 130. The first interlayer insulating layer 151 is formed with a first contact hole CH1 that exposes a part of the backplane circuit BP (more specifically, at least a part of the drain electrode of the TFT 110), and in the first contact hole CH1, the contact electrode 160 is connected to the backplane circuit BP. The second interlayer insulating layer 152 is formed with the second contact hole CH2 that exposes a part of the contact electrode 160, and the pixel electrode PE (second electrode 122 in the present embodiment) is connected to the contact electrode 160, in the second contact hole CH2.

A dielectric layer 153 is provided so as to cover the first electrode 121. The dielectric layer 153 is preferably formed of an inorganic insulating material. The inorganic insulating film obtained by using the inorganic insulating material has already been described above.

The first horizontal alignment film 140 is provided on the second electrode 122 and is in contact with the liquid crystal layer 20. Therefore, it can be said that the first electrode 121 and the second electrode 122 are disposed between the second interlayer insulating layer 152 and the first horizontal alignment film 140.

The first horizontal alignment film 140 and a second horizontal alignment film 340, which will be described later, are each subjected to an alignment treatment, and define an orientation direction (also referred to as an alignment direction) of the liquid crystal molecules 21 included in the liquid crystal layer 20. For example, the alignment treatment is preferably performed by a photo-alignment treatment or a rubbing treatment. In the photo-alignment treatment, a photo-decomposition type photo-alignment film material can be used, and in the rubbing treatment, an alignment film material such as polyimide is preferably used.

Each of the first horizontal alignment film 140 and the second horizontal alignment film 340 is a horizontal alignment film that aligns the liquid crystal molecules 21 in a direction horizontal to the first substrate 10 and the second substrate 30, in a state where no voltage is applied to the liquid crystal layer 20. That is, the liquid crystal molecules 21 are horizontally oriented in a state where no voltage is applied to the liquid crystal layer 20. A pretilt angle is substantially 0°.

The orientation direction of the liquid crystal molecules 21 defined by the first horizontal alignment film 140 and the orientation direction of the liquid crystal molecules 21 defined by the second horizontal alignment film 340 are different from each other. Therefore, the liquid crystal layer 20 takes a twist alignment when no voltage is applied (see FIG. 2). When a voltage is applied to the liquid crystal layer 20, that is, when a transverse electrical field is generated in the liquid crystal layer 20 by the first electrode 121 and the second electrode 122, an alignment state of the liquid crystal layer 20 is changed by the transverse electrical field (fringe electrical field).

A thickness of each horizontal alignment film is not particularly limited, but is preferably from 0.06 μm to 0.14 μm, for example.

### Second Substrate

The second substrate 30 is disposed to face the first substrate 10 with the liquid crystal layer 20 interposed therebetween, and includes the second horizontal alignment film 340 in contact with the liquid crystal layer 20. The second substrate 30 preferably further includes a support substrate 300 and a color filter layer 310. For example, as illustrated in FIG. 2, the second substrate 30 includes the second horizontal alignment film 340, the color filter layer 310, and the support substrate 300, in order from the liquid crystal layer 20 side. The second substrate 30 also preferably includes a plurality of columnar spacers (not illustrated). Note that the first substrate 10 may include a plurality of columnar spacers.

The support substrate 300 is preferably transparent and has an insulating property, and examples of the support substrate 300 include a glass substrate and a plastic substrate.

The color filter layer 310 typically includes a red color filter being provided in a region corresponding to a red pixel and transmitting red light, a green color filter being provided in a region corresponding to a green pixel and transmitting green light, and a blue color filter being provided in a region corresponding to a blue pixel and transmitting blue light. However, the number of types of color filters may be two or less, or four or greater. When color display is not performed, the color filter layer 310 is omitted. Additionally, when the color filter layer is formed on the first substrate 10, it is preferable that the second substrate 30 do not include the color filter layer.

An overcoat layer (also referred to as a flattened layer) may be provided to cover the color filter layer 310 if necessary. Note that depending on a material forming an electrode (for example, a transparent conductive material), a material forming an interlayer insulating layer or a dielectric layer, and a material forming an alignment film, the white display may be yellowish. In this case, chromaticity adjustment (that is, blue shift) may be performed by forming the overcoat layer with a blue resist to bring the chromaticity of the white display close to the chromaticity of a D65 light source, for example. The D65 light source is a CIE standard light source D65.

### Liquid Crystal Layer

The liquid crystal layer 20 is located between the first substrate 10 and the second substrate 30 and includes a positive type liquid crystal material. The positive type liquid crystal material means a nematic liquid crystal material having a positive anisotropy of dielectric constant Δε. The negative type liquid crystal material means a nematic liquid crystal material having a negative anisotropy of dielectric constant Δε. The anisotropy of dielectric constant Δε is a difference between the dielectric constant ε_{//} in the long axis direction and the dielectric constant ε_{⊥} in the short axis direction of the liquid crystal molecules 21 (that is, ε_{//}-ε_{⊥}).

The liquid crystal layer 20 may further include a chiral agent, if necessary. The liquid crystal layer 20 can be formed, for example, by a dropping method.

A thickness d (also referred to as a cell gap or a cell thickness) of the liquid crystal layer 20 is preferably equal to or more than 1.5 μm, for example. An upper limit of the thickness is not particularly limited, but is preferably equal to or less than 10 μm, for example. More preferably, the upper limit is equal to or less than 5 μm.

The liquid crystal layer 20 may have a multi-domain alignment such as a dual domain alignment. However, in a case where the dual domain design of transmissive FFS is applied to reflective FFS as it is, when θa exceeds 90 degrees, the pixel behaves as a pixel having a low reflectivity, and a reflectivity loss may occur. Thus, the single domain alignment (also referred to as monodomain alignment) is preferable.

The liquid crystal material constituting the liquid crystal layer 20 has a positive anisotropy of dielectric constant Δε. In general, when the absolute value of Δε is less than 2, the anisotropy of dielectric constant is not exhibited, and thus, a lower limit value of Δε is suitably equal to or more than 2. The absolute value is more preferably equal to or more than 3. Additionally, an upper limit thereof is preferably equal to or less than 15 from the viewpoint of further increasing a reflectivity (for example, a white reflectivity in the normally black mode). The upper limit is more preferably equal to or less than 10, and still more preferably equal to or less than 7.

In consideration of the absolute value of Δn of a liquid crystal molecule having the lowest refractive index (Δn=0.038 for the alkenyl derivative having the lowest refractive index), the liquid crystal material preferably has a birefringence index of Δn being more than 0.05. Δn is preferably equal to or larger than 0.06, and most preferably equal to or larger than 0.077. An upper limit is preferably equal to or less than 0.2 from the viewpoint of achieving well-balanced performance as a liquid crystal mixture for a display. The upper limit is more preferably equal to or less than 0.1, and most preferably equal to or less than 0.09.

From the viewpoint of enhancing response characteristics, the liquid crystal material preferably has a twist elastic constant K₂₂ (unit: pN) being equal to or more than 2. The twist elastic constant is more preferably equal to or more than 3. Further, from the viewpoint of voltage reduction, an upper limit thereof is preferably equal to or less than 10. The upper limit is more preferably equal to or less than 7, and still more preferably equal to or less than 6.

The above-described liquid crystal material has a spray elastic constant K₁₁ (unit: pN) tends to be directly proportional to K₂₂ in a relationship of approximately two times, and thus is preferably equal to or more than 4 and equal to or less than 20. The spray elastic constant is preferably equal to or more than 6 and equal to or less than 14. Further, a bend elastic constant K₃₃ (unit: pN) does not greatly affect optical characteristics of this mode, but is preferably equal to or more than 6 and equal to or less than 20. More preferably, the bend elastic constant is within a range equal to or more than 10 and equal to or less than 16. Note that each of the elastic constants (K₁₁, K₂₂, and K₃₃) can be calculated by theoretical formula fitting using measured values of a capacitance-voltage characteristic curve.

The liquid crystal material includes liquid crystal molecules (also referred to as positive-type liquid crystal molecules), and an average azimuth angle φLCave of the liquid crystal molecules when a voltage is applied is preferably equal to or more than 1500 and equal to or less than 156°. Within this range, a positional relationship between the extending direction of the plurality of belt-shaped portions SP and the liquid crystal molecules 21 when no voltage is applied and the rotation direction of the liquid crystal molecules 21 when a voltage is applied can be more easily set to the above-described form. A lower limit is more preferably equal to or more than 151°. In addition, an upper limit is more preferably equal to or less than 155°, still more preferably equal to or less than 154°, and particularly preferably equal to or less than 153°.

In the present specification, the average azimuth angle φLCave of the liquid crystal molecules when a voltage is applied is a numerical value obtained by performing calculation of a liquid crystal director at a voltage at which a reflectivity becomes maximum in simulation software (LCD Master 2D) manufactured by SHINTECH Co., Ltd., calculating an azimuth angle distribution of the liquid crystal molecules therein, and deriving the average azimuth angle φLCave by calculation. Details of the calculation method will be described below.

### Method of Calculating φLCave

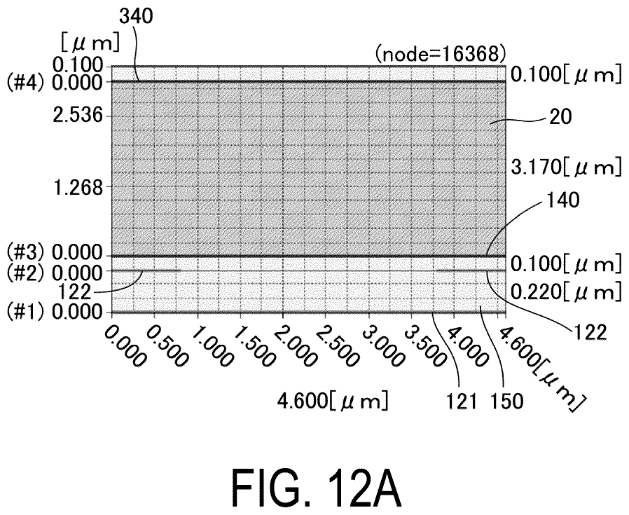

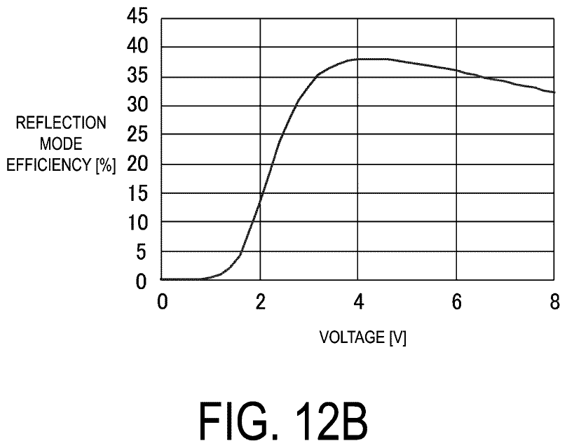

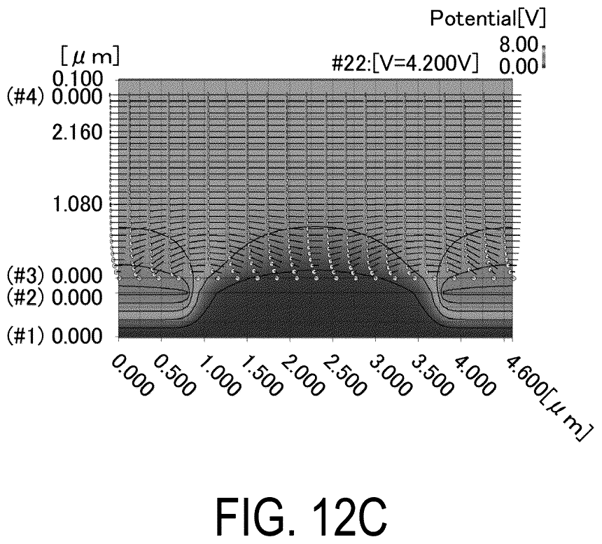

(1) A calculation model illustrated in FIG. 12A is created. A lateral width of the pixel is 4.6 m. The first electrode 121 serves as the common electrode CE, and the second electrode 122 serves as the pixel electrode PE. The common electrode CE is a solid electrode, and the pixel electrode PE (122) is a slit electrode in which the width L per belt-shaped portion is 1.6 μm and the width S per slit is 3.0 μm. The liquid crystal layer 20 is divided at intervals of 0.05 μm in an X direction (lateral direction) and at intervals of 0.025 μm in a Z direction (thickness direction). In this calculation model, the liquid crystal layer 20 is formed in a matrix shape including 21 points in the X direction and 31 points in the Z direction, that is, 651 points in total, and an azimuth angle and a polar angle of the liquid crystal molecules at each point of the matrix are calculated according to an applied voltage. FIG. 12A is a diagram illustrating a calculation model of a liquid crystal director distribution diagram.

(2) In this calculation model, a voltage of, for example, from 0 V to 8 V is applied to the pixel electrode PE (122) at intervals of 0.1 V to calculate a VR curve. An example of this calculation is illustrated in FIG. 12B. In this calculation example, the maximum reflectivity was obtained at an applied voltage of 4.2 V (see FIG. 12B). FIG. 12B is a diagram illustrating a calculation example of the VR curve.

(3) A director distribution of liquid crystal molecules at the applied voltage (that is, 4.2 V) at which the maximum reflectivity is exhibited is calculated by using simulation software (LCD Master 2D) manufactured by SHINTECH Co., Ltd. The obtained director distribution diagram of the liquid crystal molecules (also referred to as liquid crystal director distribution diagram) is illustrated in FIG. 12C. FIG. 12C is a liquid crystal director distribution diagram (cross-sectional view).

(4) An azimuth angle φ and a polar angle θ are extracted for each of directors of the liquid crystal molecules obtained in (3) described above (that is, directors at 21 points in the X direction×31 points in the Z direction=651 points in total).

(5) An average value of all azimuth angles (that is, a sum of azimuth angles at 651 points in total/651) is obtained. The value calculated in this way is the average azimuth angle φLCave of the liquid crystal molecules when a voltage is applied.

In the liquid crystal material, a ratio (Δn₆₀/Δn₂₀) of a birefringence index Δn₆₀ at 60° C. to a birefringence index Δn₂₀ at 20° C. is preferably equal to or more than 0.80. In general, an upper limit of a temperature in actual use of the liquid crystal display device is about 50° C. Thus, when Δn₆₀/Δn₂₀ is within the above range, it is possible to obtain display in which the influence of temperature is sufficiently suppressed at the temperature in actual use. In particular, black floating at the time of black display is sufficiently suppressed. The ratio is more preferably equal to or more than 0.82, and still more preferably equal to or more than 0.84. In addition, an upper limit thereof is preferably equal to or less than 0.97, and still more preferably equal to or less than 0.95, from the viewpoint of suppressing contrast reduction.

A retardation (dΔn) of the liquid crystal layer 20 that is expressed by a product of the thickness d of the liquid crystal layer 20 and the birefringence index Δn of the liquid crystal material is preferably equal to or more than 180 nm and equal to or less than 280 nm. This can achieve a lower voltage and further improve the reflectivity. The retardation is more preferably equal to or more than 200 nm and equal to or less than 260 nm, still more preferably equal to or more than 220 nm and equal to or less than 252 nm, and particularly preferably equal to or more than 236 nm and equal to or less than 252 nm. Further, the retardation is more particularly preferably equal to or less than 250 nm.

As described above, the liquid crystal layer 20 takes the twist alignment when no voltage is applied. That is, in the liquid crystal display device 1 according to the present embodiment, display is performed in the transverse electrical field type in which the liquid crystal layer 20 takes the twist alignment when no voltage is applied. As a result, the cell gap can be increased, and a variation width of contrast can be reduced with respect to a variation of the cell gap. Therefore, occurrence of display unevenness is sufficiently suppressed, and contrast of reflective display is improved. A twist angle θ₁ of the liquid crystal layer 20 when no voltage is applied will be described later.

In the present embodiment, when the liquid crystal layer 20 of each pixel P is viewed in a plan view when no voltage is applied, the extending direction of the plurality of belt-shaped portions SP is located between a long axis direction a of the liquid crystal molecule 21 on the first substrate 10 side and a long axis direction b of the liquid crystal molecule 21 on the second substrate 30 side at least in a central portion of the liquid crystal layer 20 in a plane direction. In addition, in a case where the liquid crystal layer 20 of each pixel P is viewed in the plan view and a voltage is applied, at least the liquid crystal molecules 21 in a central portion of the liquid crystal layer 20 in the thickness direction rotate in a twist direction when no voltage is applied. Such a configuration can be achieved by appropriately adjusting, for example, a twist angle θ₁ or the above-described various physical properties of the liquid crystal material. With such a configuration, a reverse twist alignment occurs in the liquid crystal layer 20. Thus, for example, in a case of the normally black mode, all the liquid crystal molecules of the liquid crystal layer 20 are in an alignment state quite similar to homogeneous alignment at the time of the white display. This improves light use efficiency and increases a white reflectivity, resulting in obtaining a high reflectivity even when the white display is performed at a low drive voltage.

Note that the liquid crystal molecules 21 on the first substrate 10 side (that is, the liquid crystal molecules 21 in a vicinity of the first horizontal alignment film 140) are also referred to as liquid crystal molecules 21A, and the liquid crystal molecules 21 on the second substrate 30 side (that is, the liquid crystal molecules 21 in a vicinity of the second horizontal alignment film 340) are also referred to as liquid crystal molecules 21B.

The central portion of the liquid crystal layer 20 in the plane direction is also referred to as a central portion of the liquid crystal layer 20 in the horizontal direction and means a central portion of the liquid crystal layer 20 in the plan view. That is, it means the vicinity of the central portion of the liquid crystal layer 20 when a liquid crystal panel 1X is viewed from the observation face side. Additionally, the central portion of the liquid crystal layer 20 in the thickness direction refers to the central portion of the liquid crystal layer 20 in a cross-sectional view. That is, it means the vicinity of the center of the liquid crystal layer 20 when the liquid crystal panel 1X is viewed from the side thereof. Thus, the liquid crystal molecules 21 located in the central portion of the liquid crystal layer 20 in the thickness direction are located substantially in the middle between the liquid crystal molecules 21A on the first substrate 10 side and the liquid crystal molecules 21B on the second substrate 30 side. The liquid crystal molecules 21 located in the central portion of the liquid crystal layer 20 in the thickness direction are also referred to as liquid crystal molecules 21C.

In a plan view of the liquid crystal layer 20 of each pixel P when no voltage is applied, the expression “the extending direction of the plurality of belt-shaped portions SP is located between the long axis direction a of the liquid crystal molecule 21A and the long axis direction b of the liquid crystal molecule 21B at least in the central portion of the liquid crystal layer 20 in the plane direction” means that the following relational formula (1) is satisfied at least in the central portion of the liquid crystal layer 20 in the plane direction when no voltage is applied:

θₐ<θ_{SP}<(θₐ+θ₁) (1).

In the above formula, θₐ is an angle of an alignment direction a of the liquid crystal molecules 21A on the first substrate 10 side when no voltage is applied, in a case where a direction parallel to the gate wiring line GL is used as the reference (0°), and then an angle formed when the extending direction is rotated clockwise is defined as a positive angle (+) and an angle formed when the extending direction is rotated counterclockwise is defined as a negative angle (−). In a case of the positive type liquid crystal molecules, an alignment direction of the liquid crystal molecules 21A corresponds to the long axis direction of the liquid crystal molecule 21A. θ_{SP} is an angle (slit angle) from the reference (0°) to the extending direction of the plurality of belt-shaped portions SP. (θₐ+θ₁) represents a sum of θₐ and θ₁, and θ₁ is a twist angle. The twist angle is an angle formed by the long axis direction a of the liquid crystal molecule 21A at which no voltage is applied and the long axis direction b of the liquid crystal molecule 21B at which no voltage is applied (that is, an angle formed by an orientation direction of the liquid crystal molecules 21A defined by the first horizontal alignment film 140 and an orientation direction of the liquid crystal molecules 21B defined by the second horizontal alignment film 340).

θₐ is preferably from 10° to 90°, for example. That is, it is preferable to control the alignment of the liquid crystal molecules 21A by the first horizontal alignment film such that the above relational formula (1) is satisfied and θₐ becomes this angle. A lower limit is more preferably equal to or more than 30°, still more preferably equal to or more than 45°, and particularly preferably equal to or more than 60°. An upper limit is more preferably equal to or less than 89°, still more preferably equal to or less than 85°, particularly preferably equal to or less than 83°, and most preferably equal to or less than 80°.

The slit angle θ_{SP} is preferably, for example, from 300 to 150°. That is, it is preferable to design the slit electrode such that the above relational formula (1) is satisfied and θ_{SP} becomes this angle. A lower limit may be a numerical value exceeding θₐ, and is, for example, more preferably equal to or more than 45°, still more preferably equal to or more than 60°, and particularly preferably equal to or more than 80°. An upper limit is more preferably equal to or less than 120°, and still more preferably equal to or less than 100°.

The twist angle θ₁ is equal to or more than 780 and equal to or less than 90°. Above all, from the viewpoint of achieving a lower voltage and further improving the reflectivity, the twist angle is preferably equal to or more than 80°, and more preferably equal to or more than 83°. In addition, when the twist angle θ₁ is 90°, there is a concern that alignment disorder may occur due to a pressure applied to a surface of the liquid crystal panel or the like, and thus, the twist angle is preferably less than 90°. From the viewpoint of further improving response characteristics, the twist angle is more preferably equal to or less than 88°, and still more preferably equal to or less than 87°. From the viewpoints of the maximum reflectivity, a maximum reflectivity voltage, and the response characteristics, the twist angle is particularly preferably equal to or more than 780 and equal to or less than 88°, more preferably equal to or more than 830 and equal to or less than 87°, and most preferably 83°.

For example, when θₐ=80°, the slit angle θ_{SP}=90°, and the twist angle θ1=83°, the liquid crystal molecule 21A, the liquid crystal molecule 21B, and the extending direction of the plurality of belt-shaped portions SP included in the slit electrode conceptually have a positional relationship as illustrated in FIG. 6.

In the present embodiment where the twist angle is within the positive numeral value range, the twist direction when no voltage is applied is a positive direction (that is, counterclockwise direction). Thus, when the liquid crystal layer 20 of each pixel P is viewed in the plan view, the expression “when a voltage is applied, at least the liquid crystal molecules 21C in the central portion of the liquid crystal layer 20 in the thickness direction rotate in the twist direction when no voltage is applied” means that at least the liquid crystal molecules 21C rotate in the positive direction when a voltage is applied.

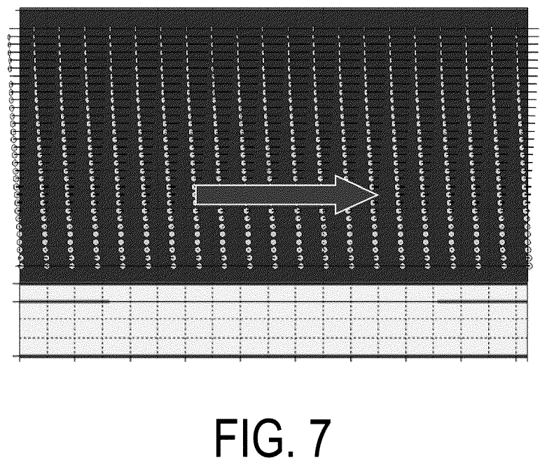

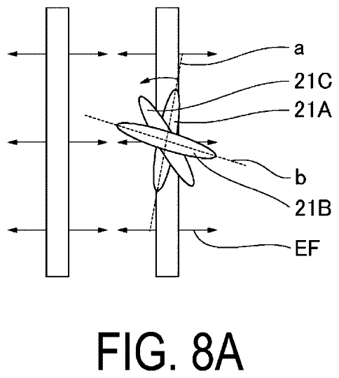

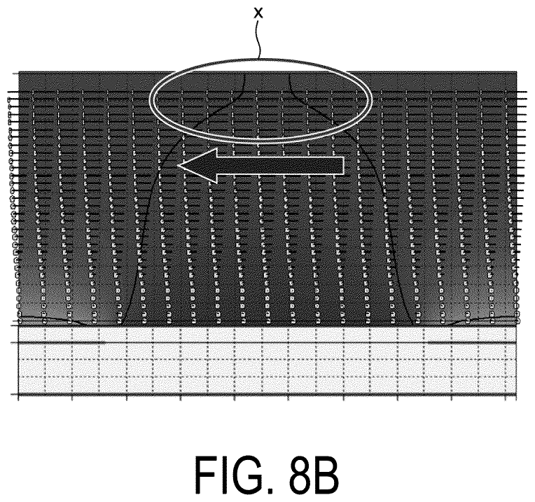

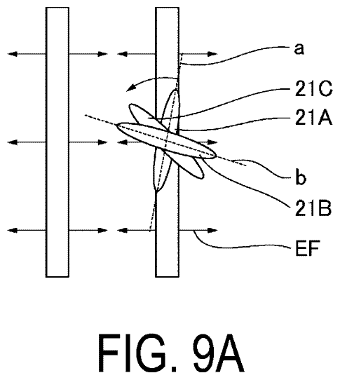

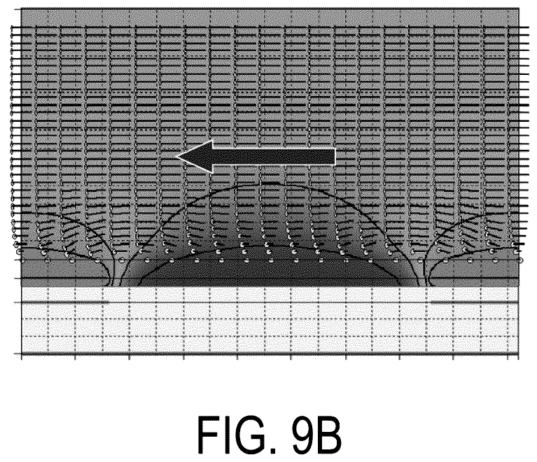

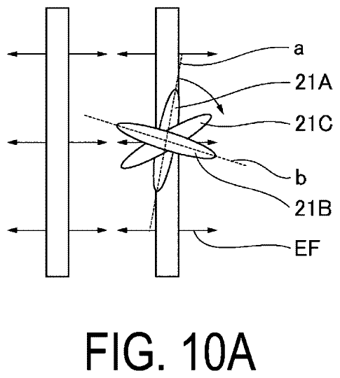

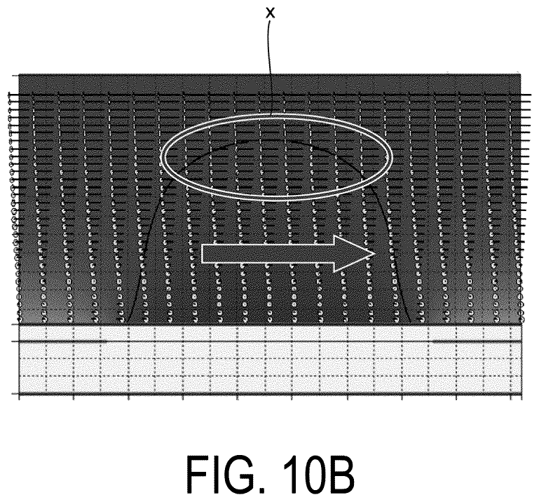

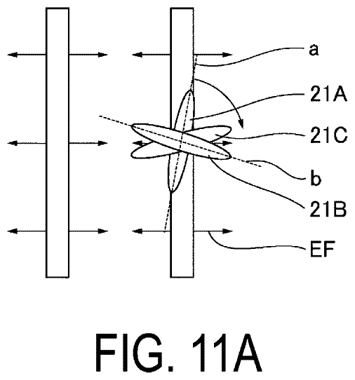

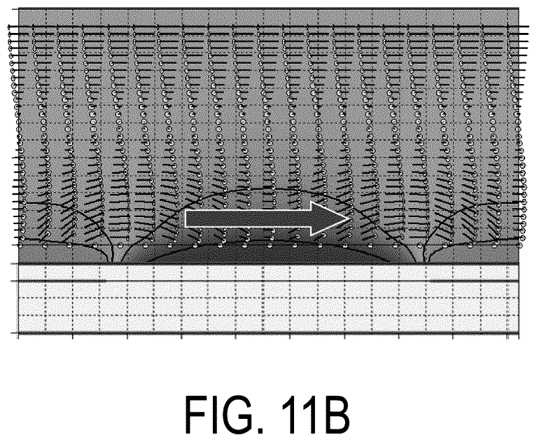

As described above, in the present embodiment, the reverse twist alignment occurs in the liquid crystal layer 20, and a mechanism by which the reverse twist alignment occurs will be described below with reference to, for example, FIG. 6, FIG. 7, FIGS. 8A and 8B, and FIGS. 9A and 9B. In addition, a mechanism by which a forward twist alignment occurs will be described below with reference to FIG. 6, FIG. 7, FIGS. 10A and 10B, and FIGS. 11A and 11B. Here, an aspect of the present embodiment in which the liquid crystal panel 1X is in the normally black mode will be described as an example.

FIG. 6, FIG. 8A, FIG. 9A, FIG. 10A, and FIG. 11A are enlarged schematic plan views of a part of FIG. 5, and are schematic plan views conceptually illustrating a relationship of the extending direction of belt-shaped portions SP of the second electrode 122 (pixel electrode PE in the present example) and the alignment direction of the liquid crystal molecules 21. However, the first electrode 121 (the common electrode CE in the present example) and the like are omitted. FIG. 7, FIG. 8B, FIG. 9B, FIG. 10B and FIG. 11B are liquid crystal director distribution diagrams (cross-sectional views).

FIG. 6 conceptually illustrates a positional relationship between the extending direction of the belt-shaped portions SP and the alignment direction of the liquid crystal molecules 21 when no voltage is applied (that is, when a voltage of 0 V is applied). FIG. 7 illustrates a liquid crystal director distribution diagram (cross-sectional view) when no voltage is applied. The positional relationship between the extending direction of the belt-shaped portions SP and the alignment direction of the liquid crystal molecules 21 when a threshold voltage (for example, a voltage of 1.8 V) is applied is conceptually illustrated in FIG. 8A in the case of the reverse twist alignment and conceptually illustrated in FIG. 10A in the case of the forward twist alignment. The liquid crystal director distribution diagram (cross-sectional view) when the threshold voltage is applied is illustrated in FIG. 8B in the case of the reverse twist alignment and is illustrated in FIG. 10B in the case of the forward twist alignment. In addition, the positional relationship between the extending direction of the belt-shaped portions SP and the alignment direction of the liquid crystal molecules 21 when a white voltage (for example, 4.0 V) is applied is conceptually illustrated in FIG. 9A in the case of the reverse twist alignment and conceptually illustrated in FIG. 11A in the case of the forward twist alignment. The liquid crystal director distribution diagram (cross-sectional view) when a white voltage is applied is illustrated in FIG. 9B in the case of the reverse twist alignment and is illustrated in FIG. 11B in the case of the forward twist alignment. For reference, a model of the liquid crystal director distribution diagram is illustrated in FIG. 12A.

For example, when θₐ=80°, the slit angle θ_{SP}=90°, and the twist angle θ1=83° are held, conceptually, the extending direction of the belt-shaped portions SP and the alignment direction of the liquid crystal molecules 21 when no voltage is applied have a positional relationship in the plan view, as illustrated in FIG. 6. The liquid crystal molecules 21 at this time are twisted in the direction of an arrow illustrated in FIG. 7 (the right direction in the drawing) in a cross-sectional view (see FIG. 7).

In the configuration in which the reverse twist alignment occurs, when a voltage (for example, 1.8 V) around a liquid crystal threshold value is applied, equipotential lines reach the counter substrate (that is, the second substrate 30) (see x in FIG. 8B). According to this, the liquid crystal molecules 21 of the entire liquid crystal layer 20 including the liquid crystal molecules 21B at an interface on the second substrate 30 side are simultaneously rotated by an elastic action. For example, when the liquid crystal molecules 21C located in the central portion of the liquid crystal layer 20 in the thickness direction are viewed in the plan view from the observation face side, the liquid crystal molecules 21C rotate counterclockwise, that is, the twist direction (see FIG. 8A). Further, when a white voltage (for example, 4.0 V) is applied, the liquid crystal molecules 21C further rotate counterclockwise (see FIG. 9A). In the cross-sectional view, substantially all of the liquid crystal molecules 21 included in the liquid crystal layer 20 are twisted in an untwisted direction (the left direction in FIG. 9B) (see FIG. 9B).

On the other hand, in the configuration in which the forward twist alignment occurs, when a voltage around the liquid crystal threshold value (for example, 1.8 V) is applied, the equipotential lines do not reach the counter substrate (that is, the second substrate 30) (see x in FIG. 10B). Thus, the liquid crystal molecules 21A at an interface on the first substrate 10 side mainly rotate, and when the liquid crystal molecules 21C in the central portion of the liquid crystal layer 20 in the thickness direction are viewed in the plan view from the observation face side, the liquid crystal molecules 21C rotate in the clockwise direction that is the opposite direction to the twist direction (see FIG. 10A). Further, when a white voltage (for example, 4.0 V) is applied, the liquid crystal molecules 21C further rotate clockwise (see FIG. 11A). In the cross-sectional view, the liquid crystal molecules 21 further rotate in an initial twist direction (the right direction in FIG. 11B) (see FIG. 11B) according to the electrical field direction that starts to move around the threshold voltage. Due to such an influence of the liquid crystal molecules 21 in the twist direction, an optical rotation and double refraction are mixed, and the white reflectivity is not improved.

The behavior of the liquid crystal molecules 21 in the present embodiment will be further described below with reference to the accompanying drawings. Here, an aspect of the present embodiment in which the liquid crystal panel 1X is in the normally black mode will be described.

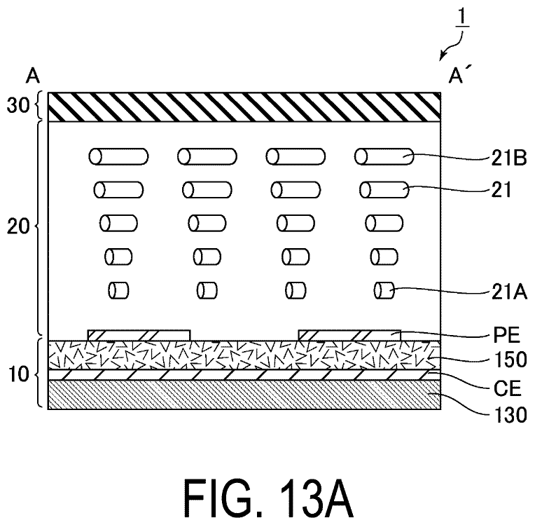

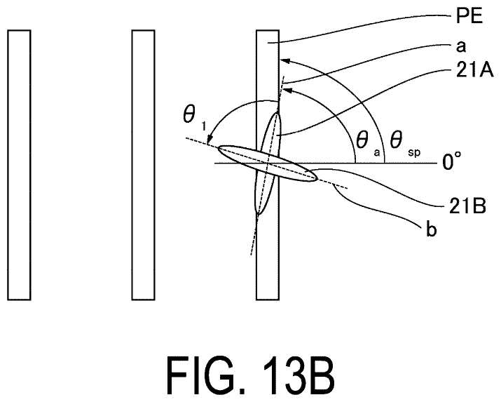

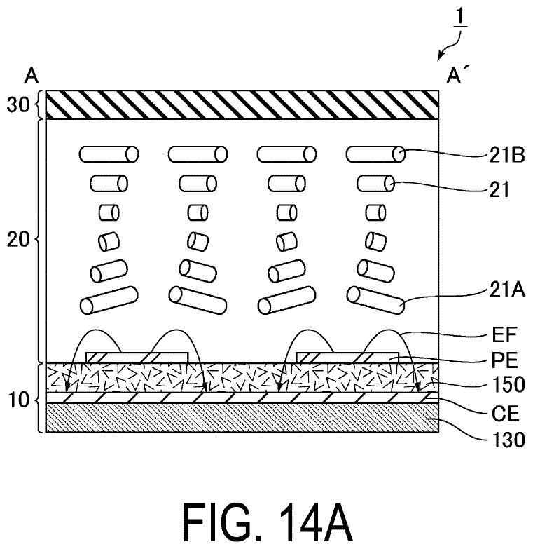

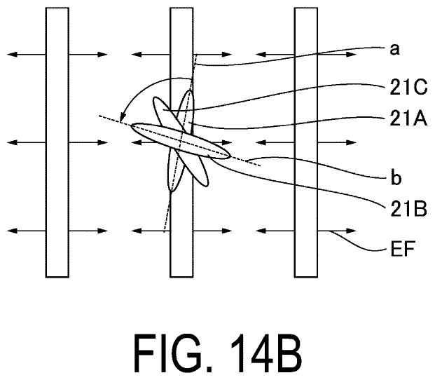

FIG. 13A is a schematic cross-sectional view taken along the line A-A′ in FIG. 5 (line A-A′ cross-sectional view), and conceptually illustrates the behavior of the liquid crystal molecules 21 when no voltage is applied (that is, in the black display state). FIG. 13B is an enlarged schematic plan view of a part of FIG. 5 and conceptually illustrates the twist direction of the liquid crystal molecules 21 when no voltage is applied (that is, in the black display state). On the other hand, FIG. 14A is a schematic cross-sectional view taken along the line A-A′ in FIG. 5 (line A-A′ cross-sectional view), and conceptually illustrates the behavior of the liquid crystal molecules 21 when a voltage is applied (that is, in the white display state). FIG. 14B is an enlarged schematic plan view of a part of FIG. 5 and conceptually illustrates the twist direction of the liquid crystal molecules 21 when a voltage is applied (that is, in the white display state).

As illustrated in FIG. 13A, when no voltage is applied, the liquid crystal molecules 21 are horizontally aligned by the first horizontal alignment film 140 and the second horizontal alignment film 340. The liquid crystal molecule 21B defined by the second horizontal alignment film 340 is twisted by the twist angle θ₁ from the liquid crystal molecule 21A defined by the first horizontal alignment film 140 (see FIG. 13B). On the other hand, when a voltage is applied, the liquid crystal molecules 21 rotate so as to have different twist angle orientations in the pixel plane due to the influence of a transverse electrical field EF generated between the first electrode 121 (the common electrode CE in the present embodiment) and the second electrode 122 (the pixel electrode PE) (see FIG. 14A and FIG. 14B).

### Manufacturing Method

The liquid crystal panel 1X can be manufactured by, for example, bonding the first substrate 10 and the second substrate 30 to each other, injecting a liquid crystal composition into a gap between the two substrates to form the liquid crystal layer 20, and then dividing the obtained structure.

As a method for manufacturing the first substrate 10 (for example, a TFT substrate), it is preferable to adopt a general method for forming a TFT substrate in an FFS mode by using a transparent electrode. As described above, an insulating film (also referred to as an insulating layer) is formed between the respective electrodes and between each of the electrodes and the gate wiring line GL, the source wiring line SL, a TFT 110, and the like. As described above, the insulating film may be an inorganic film or an organic film. Instead of the organic insulating film, a color filter layer may be formed. In addition, it is preferable that an organic insulating film be formed after the common electrode CE is formed, and the pixel electrode PE be formed after the organic insulating film is patterned.

As a method for manufacturing the second substrate 30, it is preferable to adopt a general method for forming the counter substrate in an FFS mode. Note that when the color filter layer is formed on the first substrate 10, it is preferable that the second substrate 30 do not include the color filter layer.

### Other Configurations and the Like

The liquid crystal display device 1 is suitably in the normally black mode from the viewpoint of further improving contrast. The normally black mode is a display mode in which black display is performed in a voltage non-applied state and white display is performed in a voltage applied state.

In the present embodiment, the configuration in which the pixel electrode PE is provided above the common electrode CE has been described, but in a relatively large liquid crystal display device, that is, a liquid crystal display device in which an area of the pixel P is relatively large, the pixel electrode PE is preferably provided above the common electrode CE. In such a configuration (also referred to as a V2 structure), it is not necessary to form a slit in the common electrode CE serving as a lower layer electrode, and thus, as compared with a configuration in which the common electrode CE is provided above the pixel electrode PE (also referred to as a V3 structure), an increase in resistivity (sheet resistivity) of the common electrode CE is suppressed, and therefore, a decrease in a fringe electrical field applied to the liquid crystal layer 20 is suppressed. In such a configuration (V2 structure), when the pixel electrode PE is a slit electrode, the resistivity of the pixel electrode PE increases, but since a voltage input from outside is applied to the pixel electrode PE, it is easy to reduce an influence caused due to the increase of the resistivity (that is, to suppress weakening of a fringe electrical field). Note that in order to suppress the increase in the resistivity of the common electrode CE, it is possible to consider using a low resistance wiring line formed of a metal material (for example, connecting the low resistance wiring line to a common electrode), but in such a configuration, an adverse effect on the display due to specular reflection and the like resulting from the low resistance wiring line (for example, a glare, an iridescent diffraction, and an interference pattern) may occur, and it is necessary to block light with a black matrix, and the like, and a reflection aperture ratio cannot be sufficiently improved in some cases.

In the configuration in which the pixel electrode PE is provided above the common electrode CE, the common electrode CE does not exist in a region where a second contact hole CH2 is formed, and thus, such a region no longer contributes to a reflective display, and as compared with a configuration in which the common electrode CE is provided above the pixel electrode PE, the reflectivity may be lower. The area of the region that does not contribute to the reflective display, such as the contact hole, is required to be of a certain size regardless of the size of the area of the pixel P. Thus, the proportion of the region that does not contribute to the reflective display in the pixel P increases as the area of the pixel P decreases (that is, as the definition increases), and the above-described decrease in the reflectivity becomes significant. Conversely, in a relatively large liquid crystal display device, it is easier to reduce a proportion occupied by a region not contributing to the reflective display within the pixel P, and therefore, it is easier to suppress the decrease in reflectivity described above. For these reasons, in the relatively large liquid crystal display device, it is advantageous to have the configuration in which the pixel electrode PE is provided above the common electrode CE.

On the other hand, as described above, the decrease in reflectivity due to the region where the second contact hole CH2 is formed not contributing to the reflective display becomes larger as the area of the pixel P becomes smaller (that is, as the definition becomes higher), and thus, in a liquid crystal display device having a relatively high definition, that is, in a liquid crystal display device in which the area of the pixel P is relatively small, it is preferable that the common electrode CE be provided above the pixel electrode PE (see a first modified example of the first embodiment, which will be described later).

In addition to the above-mentioned members, the liquid crystal display device 1 is configured by a plurality of members such as an external circuit such as Tape Carrier Package (TCP) and Printed Circuit Board (PCB); an optical film such as a viewing angle expansion film and a luminance enhancement film; and a bezel (frame), and some of such members may be incorporated into another member. Such members are not particularly limited, and those commonly used in the field of liquid crystal display devices can be used, and thus, the explanation will be omitted.

### Application Example

The liquid crystal display device 1 according to the present embodiment is suitably used for various purposes. In particular, the liquid crystal display device 1 can be preferably applied to a touch panel. Even when the liquid crystal display device 1 is applied to either an external touch panel or a built-in touch panel, the contrast ratio can be improved at a lower cost than a known touch panel, hence being useful. In particular, the liquid crystal display device 1 can be suitably applied to the built-in touch panel, and can be particularly suitably applied to an in-cell type touch panel. Thus, when the liquid crystal display device 1 according to the present embodiment is used, it is possible to suitably implement an in-cell type touch panel capable of performing display in a reflection mode, which has not been possible until now.

When the in-cell type touch panel capable of performing display in a reflection mode can be implemented, for example, a frame wiring line region required for an external touch panel can be eliminated, and thus, it is possible to achieve frame narrowing, and a touch panel function can be mounted without a cover glass, and thus, it is possible to contribute to reduction in thickness and weight. The touch function and the display function are driven in a time division manner, and thus, the touch panel is not affected by Liquid Crystal Display (LCD) noise which may be the largest noise source. That is, a killer pattern is not generated, and thus, tuning (adjustment) of the touch signal is easy. Further, a loss of reflected light is sufficiently small, a pen writing is more natural, and display without a sense of incongruity is obtained. Compared with the external touch panel, a total cost can be reduced from the user's viewpoint. Input by a finger and input with a pen by an Electromagnetic Induction Method (EMR) can be combined, and a highly accurate pen writing can be achieved.

An example in which the liquid crystal display device 1 is used as the in-cell type touch panel will be further described.

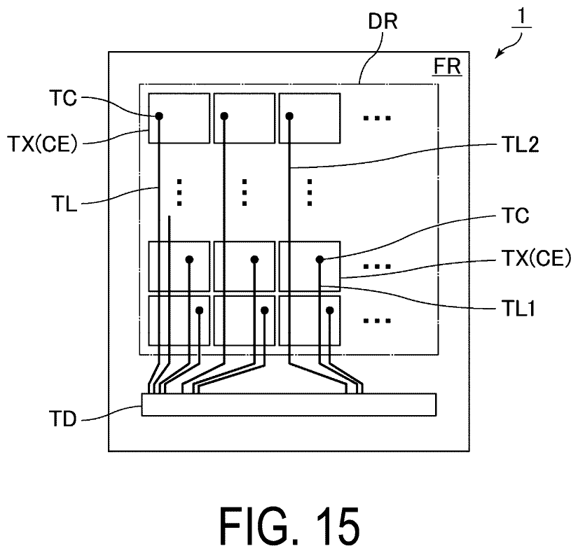

FIG. 15 is a schematic plan view illustrating, as an example, an arrangement relationship between a touch sensor electrode TX and a touch wiring line TL that are included in the liquid crystal display device 1. As illustrated in FIG. 15, the liquid crystal display device 1 includes a display region DR and a non-display region FR. The display region DR is defined by a plurality of pixels P (see, for example, FIG. 3) arrayed in a matrix shape. The non-display region FR is located around the display region DR, and is also referred to as a peripheral region or a frame region.

Within the display region DR, the common electrode CE is divided into a plurality of segments TX. Each segment (common electrode portion) TX functions as a touch sensor electrode. In the example illustrated in FIG. 15, each touch sensor electrode TX is provided corresponding to two or more pixels P.

The liquid crystal display device 1 (more specifically, the first substrate 10) includes a plurality of the touch wiring lines TL. Each touch sensor electrode TX is electrically connected to a corresponding touch wiring line TL. A connection portion TC between the touch sensor electrode TX and the touch wiring line TL is also referred to as a touch wiring line contact portion TC.

The touch wiring line TL is connected to a touch drive unit TD provided in the non-display region FR. The touch drive unit TD is configured to switch, for example, between a display mode in which the plurality of touch sensor electrodes TX function as the common electrode CE, and a touch detection mode in which the plurality of touch sensor electrodes TX function as the touch sensor electrode TX, in a time division manner. The touch drive unit TD, for example, applies a common signal to the touch sensor electrode TX (common electrode CE) through the touch wiring line TL in the display mode. On the other hand, in the touch detection mode, the touch drive unit TD applies a touch drive signal to the touch sensor electrode TX through the touch wiring line TL.

In FIG. 15, the plurality of touch wiring lines TL extend in a column direction (the same direction as the source wiring line SL). Some touch wiring lines TL extend across one or a plurality of other touch sensor electrodes TX to the corresponding touch sensor electrodes TX.

When attention is paid to one touch sensor electrode TX, a first touch wiring line TL1 for supplying a signal to the one touch sensor electrode TX extends to the touch wiring line contact portion TC, and a second touch wiring line TL2 for supplying a signal to another touch sensor electrode TX extends across the one touch sensor electrode TX. The second touch wiring line TL2 and a touch sensor electrode TX overlap each other with an insulating layer interposed therebetween. Note that depending on a position of the touch sensor electrode TX, two or more touch wiring lines TL may be arranged so as to extend across the touch sensor electrode TX, or no touch wiring line TL crossing the touch sensor electrode TX may be arranged.

In the non-display region FR, in addition to the touch drive unit TD, a peripheral circuit including drive circuits such as a gate driver that supplies a gate signal to the gate bus line (gate wiring line) GL, a source driver that supplies a source signal to the source bus line (source wiring line) SL, and the like are provided (not illustrated). These drive circuits may, for example, be mounted on the first substrate (TFT substrate) 10, or formed as an integral (monolithic) part. A semiconductor chip including some or all of the drive circuits may be mounted on the non-display region FR.

In the in-cell type touch panel, it is particularly preferable to use an In—Ga—Zn—O-based semiconductor for the TFT 110. From the viewpoint of achieving flickerlessness (also referred to as being flicker-free), it is particularly suitable to use a negative type liquid crystal material. The reason for this is as follows. In a transverse electrical field type such as an FFS mode by using the positive type liquid crystal material, due to an influence of a fine slit electrode on an electrode (that is, a fringe electrical field) when a voltage is applied, flexoelectric polarization spontaneously occurs in the liquid crystal layer. It is considered that the liquid crystal responds according to the flexoelectric polarization, and thus, a luminance changes at the time of polarity inversion, and therefore flicker is easily visually recognized.

### First Modified Example of First Embodiment

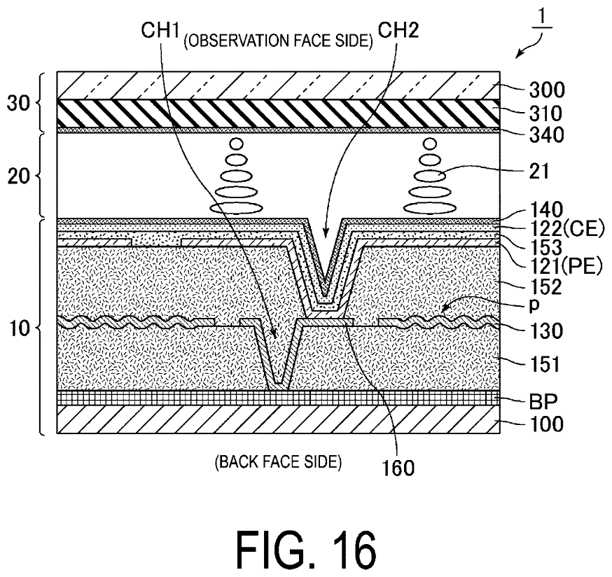

In the first embodiment, the configuration in which the first electrode 121 serving as a lower layer electrode is the common electrode CE and the second electrode 122 serving as an upper layer electrode is the pixel electrode PE has been described. However, conversely, the second electrode 122 may be the common electrode CE and the first electrode 121 may be the pixel electrode PE. In the present example, the second electrode 122 (upper layer electrode) is the common electrode CE, and the first electrode 121 (lower layer electrode) is the pixel electrode PE (see FIG. 16).

FIG. 16 is a schematic cross-sectional view illustrating more specifically the liquid crystal display device 1 according to the present example. Also in the present example, it is preferable that from the viewpoint of easily generating a transverse electrical field, at least the upper layer electrode (common electrode CE in the present example) be a slit electrode. The lower layer electrode (pixel electrode PE in the present example) may be a planar electrode, that is, a so-called solid electrode, or may be a slit electrode. The liquid crystal display device 1 according to the present example is particularly suitable as a liquid crystal display device having a relatively high definition as described above, that is, a liquid crystal display device in which the area of the pixel P is relatively small.

### Second Modified Example of First Embodiment

In the first embodiment, an FFS mode liquid crystal display device has been described. However, an IPS mode liquid crystal display device may also be possible (note that the liquid crystal layer 20 takes a twist alignment when no voltage is applied). The present modified example is an IPS mode liquid crystal display device. In the present modified example, it is preferable that the first electrode 121 and the second electrode 122 be provided in the same layer, and each of both the first electrode 121 and the second electrode 122 be a slit electrode.

### Second Embodiment

In the present embodiment, features unique to the present embodiment will be mainly described, and a description of contents overlapping the above-described first embodiment will be omitted. The present embodiment is substantially the same as the first embodiment except that the liquid crystal display device further includes a phase difference layer 40 and a polarizer 50.

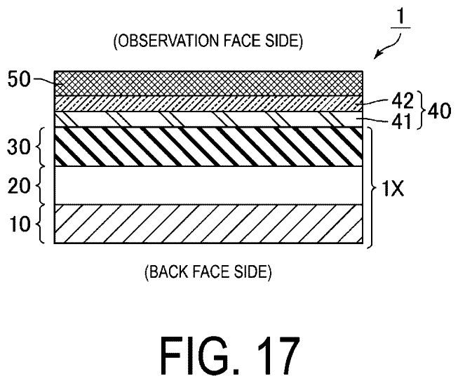

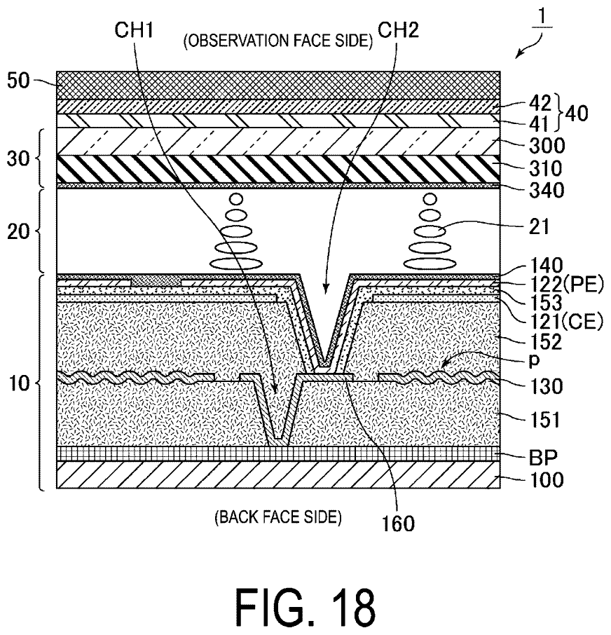

FIG. 17 is a schematic cross-sectional view of the liquid crystal display device 1 according to the present embodiment, and FIG. 18 is a schematic cross-sectional view more specifically illustrating the liquid crystal display device 1 according to the present embodiment. As illustrated in FIG. 17, the liquid crystal display device 1 includes the first substrate 10, the liquid crystal layer 20, the second substrate 30, the phase difference layer 40, and the polarizer 50, in order from the back face side. In the present embodiment, a TFT substrate is used as the first substrate 10.

It is suitable that the phase difference layer 40 is located between the second substrate 30 and the polarizer 50, and includes a λ/4 plate 41 and a κ/2 plate 42 (see FIG. 17 and FIG. 18). When the λ/4 plate 41 and the λ/2 plate 42 are arranged, such plates 41 and 42 are suitably located in order from the liquid crystal layer 20 (and the second substrate 30) side (see FIG. 17 and FIG. 18).

The λ/4 plate means a phase difference plate that imparts an in-plane phase difference of a ¼ wavelength to incident light having a wavelength a, and is also referred to as a λ/4 wavelength plate or a Quarter-Wave Plate (QWP). Specifically, the λ/4 plate 41 is capable of converting linearly polarized light into circularly polarized light or circularly polarized light into linearly polarized light. For example, the linearly polarized light incident on the λ/4 plate 41 becomes circularly polarized light when emitted from the λ/4 plate 41.

The λ/2 plate means a phase difference plate that imparts an in-plane phase difference of a ½ wavelength to incident light having a wavelength a, and is also referred to as a λ/2 wavelength plate, a half-wavelength plate, or a Half-Wave Plate (HWP). Specifically, the λ/2 plate 42 is capable of rotating a vibration direction of an incident light beam by approximately 90°. For example, the circularly polarized light incident on the λ/2 plate 42 becomes circularly polarized light having an opposite turning direction at the time of emission.

Specifically, it is preferable to use a uniaxial A plate as the λ/4 plate 41 and the/2 plate 42.

The polarizer 50 is located closer to the observation face side with respect to the phase difference layer 40 (see FIG. 17 and FIG. 18). The polarizer 50 may be a circular polarizer or a linear polarizer. Here, the linear polarizer means a polarizer having a function of extracting polarized light (linearly polarized light) vibrating only in a specific direction from unpolarized light (natural light), partially polarized light, or polarized light, and is distinguished from a circular polarizer. In particular, the polarizer 50 is preferably the linear polarizer.

The polarizer 50 may also be an absorption-type polarizer or a reflection-type polarizer. The absorption-type polarizer is a polarizer having a function of absorbing light vibrating in a specific direction and transmitting polarized light (linearly polarized light) vibrating in a direction perpendicular to the specific direction. The reflection-type polarizer is a polarizer having a function of reflecting light vibrating in a specific direction and transmitting polarized light (linearly polarized light) vibrating in a direction perpendicular to the specific direction. In particular, the polarizer 50 is preferably the absorption-type polarizer. In particular, an absorption-type linear polarizer is suitably used.

Examples of the absorption-type polarizer include a polarizer obtained by dying and adsorbing a polyvinyl alcohol film with an anisotropic material such as an iodine complex (or dye), which is followed by then stretching and orienting the film. In general, when the absorption-type polarizer is put to actual use, in order to ensure mechanical strength and resistance to moisture and heat, a protection film such as a triacetyl cellulose film is layered on both sides of the polyvinyl alcohol film. Examples of the reflection-type polarizer include a film in which a plurality of dielectric thin films are layered, a film in which a plurality of thin films having different types of refractive index anisotropy are layered, a nanowire grid polarizer, and a polarizer using selective reflection of a Cholesteric LC.

Hereinafter, a preferable axis angle of the optical film (that is, the polarizer and a retarder/phase difference plate) will be described. The absorption-type polarizer is used as the polarizer 50.

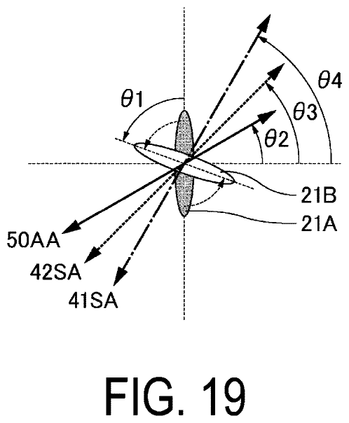

FIG. 19 is a plan view for describing the axis angle of each optical film in the liquid crystal display device 1 (see FIG. 17 and FIG. 18) including the first substrate 10, the liquid crystal layer 20, the second substrate 30, the λ/4 plate 41, the λ/2 plate 42, and the polarizer 50 in order from the back face side. In the following description, the axis angle of each optical film is an angle obtained when a reference azimuthal direction is set to a three o'clock direction (0°) and a twist direction is set to a positive (counterclockwise) direction, with FIG. 19 regarded as the dial of a timepiece. In FIG. 19, for convenience, the angle θₐ of the alignment direction (that is, the long axis direction) a of the liquid crystal molecules 21A on the first substrate 10 side when no voltage is applied is set to 90°.

An angle θ₂ formed by a polarization axis 50AA of the polarizer 50 is preferably equal to or more than 5° and equal to or less than 25°. This improves the contrast ratio. From the viewpoint of further improving the contrast ratio, such an angle is more preferably equal to or more than 8° and equal to or less than 20°, and still more preferably equal to or more than 100 and equal to or less than 15°.

An angle θ₃ formed by an in-plane slow axis 42SA of the V2 plate 42 is preferably equal to or more than 250 and equal to or less than 45°. This improves the contrast ratio. From the viewpoint of further improving the contrast ratio, such an angle is more preferably equal to or more than 260 and equal to or less than 40°, and still more preferably equal to or more than 28° and equal to or less than 35°.

An angle θ₄ formed by an in-plane slow axis 41SA of the V4 plate 41 is preferably equal to or more than 450 and equal to or less than 70°. This improves the contrast ratio. From the viewpoint of further improving the contrast ratio, such an angle is more preferably equal to or more than 480 and equal to or less than 65°, and still more preferably equal to or more than 500 and equal to or less than 60°.

Next, a principle when the liquid crystal display device 1 according to the present embodiment performs white display and black display will be described. The liquid crystal display device 1 here is assumed to include the first substrate 10, the liquid crystal layer 20, the second substrate 30, the V4 plate 41, the V2 plate 42, and the polarizer 50 in order from the back face side (see FIG. 17 and FIG. 18), and to perform display in the normally black mode.

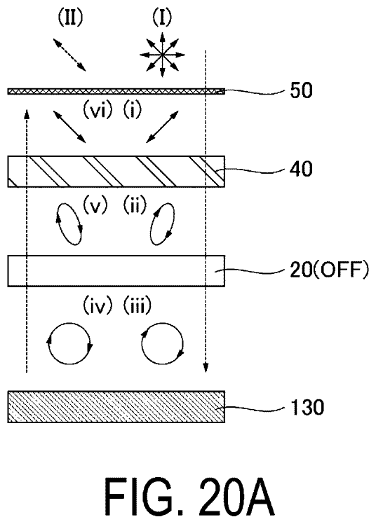

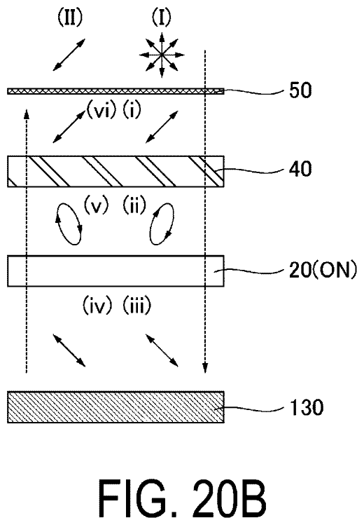

FIG. 20A is a conceptual diagram for describing the principle of performing the black display, and FIG. 20B is a conceptual diagram for describing the principle of performing the white display. In FIG. 20A and FIG. 20B, for convenience, only the reflective layer 130, the liquid crystal layer 20, the phase difference layer 40 (that is, the V4 plate 41 and the V2 plate 42), and the polarizer 50 are extracted and illustrated. A linear polarizer is used as the polarizer 50.

As illustrated in FIG. 20A, light (I) becomes linearly polarized light (i) by passing through the polarizer 50. The linearly polarized light (i) is given a phase difference of (λ/2+λ/4) by the phase difference layer 40 to become elliptically polarized light (ii). When no voltage is applied, the elliptically polarized light (ii) is provided with a phase difference of λ/4 in the liquid crystal layer 20 to become elliptically polarized light (iii). The elliptically polarized light (iii) is reflected at the reflective layer 130 and becomes elliptically polarized light (iv) whose rotation direction is opposite to that of the elliptically polarized light (iii). The elliptically polarized light (iv) is provided with a phase difference of λ/4 in the liquid crystal layer 20 to become elliptically polarized light (v). The elliptically polarized light (v) is provided with a phase difference of (λ/2+λ/4) by the phase difference layer 40 to become linearly polarized light (vi) whose vibration direction is orthogonal to that of the linearly polarized light (i). Thus, polarized light (II) is not emitted from the polarizer 50, resulting in black display.

Even when a voltage is applied, as illustrated in FIG. 20B, light (I) becomes linearly polarized light (i) by passing through the polarizer 50. The linearly polarized light (i) is given a phase difference of (λ/2+λ/4) by the phase difference layer 40 to become elliptically polarized light (ii). When a voltage is applied to the liquid crystal layer 20, the elliptically polarized light (ii) is added with a phase difference in the liquid crystal layer 20 and becomes linearly polarized light (iii) having a polarization direction obtained by rotating the linearly polarized light (i) by approximately 90°. Even when the linearly polarized light (iii) is reflected at the reflective layer 130, the polarization direction does not change (this is referred to as linearly polarized light (iv)). The phase difference of the linearly polarized light (iv) is returned in the liquid crystal layer 20 to become elliptically polarized light (v) whose rotation direction is opposite to that of the elliptically polarized light (ii). The elliptically polarized light (v) is given a phase difference of (λ/2+λ/4) by the phase difference layer 40 to become linearly polarized light (vi) having the same vibration direction as that of the linearly polarized light (i). Thus, polarized light (II) passes through the polarizer 50, resulting in white display.

### First Modified Example of Second Embodiment

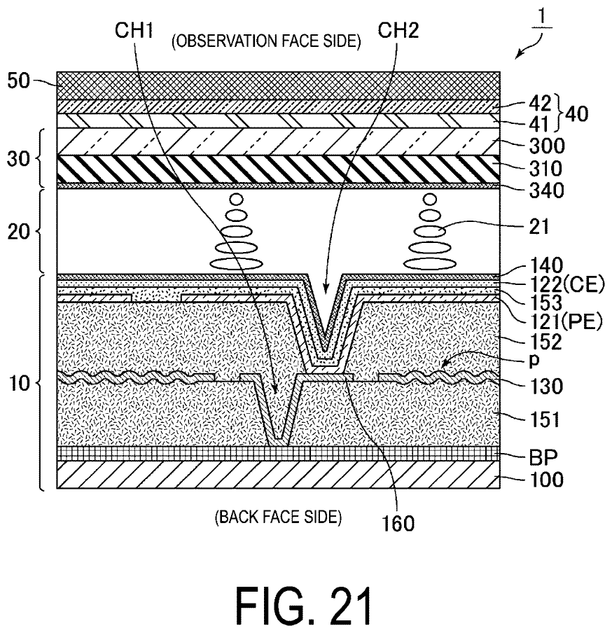

In the second embodiment, the configuration in which the first electrode 121 serving as a lower layer electrode is the common electrode CE and the second electrode 122 serving as an upper layer electrode is the pixel electrode PE has been described. However, conversely, the second electrode 122 may be the common electrode CE and the first electrode 121 may be the pixel electrode PE. In the present example, the second electrode 122 (upper layer electrode) is the common electrode CE, and the first electrode 121 (lower layer electrode) is the pixel electrode PE (see FIG. 21).

FIG. 21 is a schematic cross-sectional view more specifically illustrating the liquid crystal display device 1 according to the present example. Also in the present example, it is preferable that from the viewpoint of easily generating a transverse electrical field, at least the upper layer electrode (common electrode CE in the present example) be a slit electrode. The lower layer electrode (pixel electrode PE in the present example) may be a planar electrode, that is, a so-called solid electrode, or may be a slit electrode. The liquid crystal display device 1 according to the present modified example is particularly suitable as a liquid crystal display device having a relatively high definition as described above, that is, a liquid crystal display device in which the area of the pixel P is relatively small.

### Third Embodiment

In the present embodiment, features unique to the present embodiment will be mainly described, and a description of contents overlapping the above-described first and second embodiments will be omitted. Although the reflective liquid crystal display device has been described as an example in the first and second embodiments, a transflective liquid crystal display device will be described in the present embodiment. The liquid crystal display device of the present embodiment is different from the liquid crystal display device of the second embodiment mainly in that a light source is provided closer to the back face side relative to the liquid crystal layer 20.

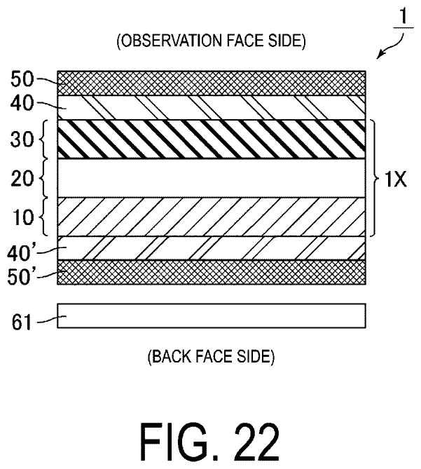

FIG. 22 is a schematic cross-sectional view of the liquid crystal display device 1 according to the present embodiment. The liquid crystal display device 1 further includes a light source 61 (also referred to as a backlight) closer to the back face side relative to the liquid crystal layer 20. It is preferable to further include a polarizer 50′ and a phase difference layer 40′. More preferably, as illustrated in FIG. 22, the liquid crystal display device 1 includes the light source 61, the polarizer 50′, the phase difference layer 40′, the first substrate 10, the liquid crystal layer 20, the second substrate 30, the phase difference layer 40, and the polarizer 50, in order from the back face side. Also in the present embodiment, the TFT substrate is suitable as the first substrate 10.

The light source 61 (backlight) is not particularly limited as long as the light source 61 emits light, and may be a direct type, an edge type, or any other type. Specifically, for example, the light source 61 preferably has a light source such as a Light Emitting Diode (LED), a light guide plate, and a reflective sheet, and may further include a diffuser sheet or a prism sheet.

The polarizer 50′ is arranged on the back face side of the liquid crystal layer 20. More specifically, the polarizer 50′ is arranged closer to the back face side relative to the first substrate 10. The polarizer 50′ may be a circular polarizer or a linear polarizer, but is preferably a linear polarizer. The polarizer 50′ may be an absorption-type polarizer or a reflection-type polarizer, but is preferably an absorption-type polarizer. In particular, an absorption-type linear polarizer is suitably used.

The polarization axis of the polarizer 50′ may be arranged so as to be substantially orthogonal to the polarization axis of the polarizer 50 or so as to be substantially parallel thereto. That is, the polarizer 50′ may be arranged in a crossed-Nicol state or in a parallel Nicol state with respect to the polarizer 50. In particular, the arrangement in the crossed-Nicol state is preferable.

The phase difference layer 40′ is arranged between the polarizer 50′ and the liquid crystal layer 20. More specifically, the phase difference layer 40′ is arranged between the polarizer 50′ and the first substrate 10. The phase difference layer 40′ may include, for example, a λ/4 plate and a λ/2 plate. When such members are arranged, for example, the λ/2 plate and the λ/4 plate are suitably arranged in order from the back face side.

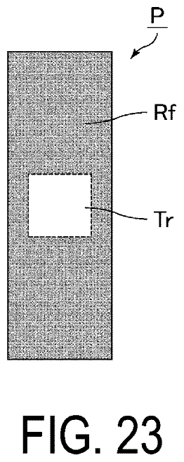

In the liquid crystal display device 1 according to the present embodiment, each pixel P includes a reflective region Rf for display in a reflection mode and a transmissive region Tr for display in a transmission mode (see FIG. 23). FIG. 23 is a schematic plan view conceptually illustrating that each pixel P includes the reflective region Rf and the transmissive region Tr in the liquid crystal display device 1 of the present embodiment. The reflective layer 130 (see FIG. 2, for example) is disposed in the reflective region Rf, but the reflective layer 130 is not disposed in the transmissive region Tr. A proportion of an area occupied by the transmissive region Tr in each pixel P can be set as appropriate depending on each application, but is preferably equal to or more than 20% and equal to or less than 90%, for example. A position and a shape of the transmissive region Tr within the pixel P may also be appropriately set depending on the application or the like.

In the liquid crystal display device according to the present embodiment, that is, a transflective liquid crystal display device, similarly to the reflective liquid crystal display device, by performing display of the transverse electrical field type in which the liquid crystal layer 20 takes the twist alignment when no voltage is applied, it is possible to sufficiently improve the contrast ratio of the reflective display. Therefore, the liquid crystal display device 1 of the present embodiment is also capable of improving the contrast ratio at low cost and is useful as the in-cell type touch panel capable of performing display in the reflection mode.

### Fourth Embodiment

In the present embodiment, features unique to the present embodiment will be mainly described, and a description of contents overlapping the above-described first embodiment will be omitted. The liquid crystal display device of the present embodiment is different from the liquid crystal display device of the first embodiment mainly in that the light source is provided closer to the observation face side relative to the liquid crystal layer 20. Note that the liquid crystal display device of the present embodiment is the reflective liquid crystal display device.

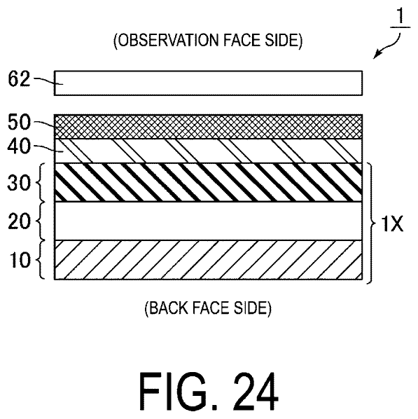

FIG. 24 is a schematic cross-sectional view of the liquid crystal display device 1 according to the present embodiment. The liquid crystal display device 1 according to the present embodiment further includes a light source 62 (also referred to as a front light) closer to the observation face side relative to the liquid crystal layer 20. More preferably, as illustrated in FIG. 24, the liquid crystal display device 1 according to the present embodiment includes the first substrate 10, the liquid crystal layer 20, the second substrate 30, the phase difference layer 40, the polarizer 50, and the light source 62, in order from the back face side. Also in the present embodiment, the TFT substrate is suitable as the first substrate 10.

The light source 62 (front light) is not particularly limited as long as the light source 62 emits light. Specifically, for example, the light source 62 preferably includes a light guide plate and a light source such as a Light Emitting Diode (LED). The reflective liquid crystal display device 1 further includes the light source 62, which causes a bright reflective display to be performed even in an environment where sufficient ambient light is not available.

Although the embodiments of the disclosure have been described above, all the individual matters described can be applied to the disclosure in general.

The disclosure will be described in more detail below by using specific examples, but the disclosure is not limited to only these examples.

In the following verification examples, LCD Master 2D manufactured by SHINTECH Co., Ltd. was used as simulation software. Further, various physical properties of liquid crystal materials de5, de6, de7, de10 and de15 used in the verification examples are shown in the following table.

TABLE 1

| | Liquid Crystal Material No. | | | | |
|---|---|---|---|---|---|
| | de5 | de6 | de7 | de10 | de15 |
| Δn | 0.077 | 0.077 | 0.077 | 0.077 | 0.077 |
| Δε | 5.3 | 6.3 | 7.3 | 10.3 | 15.3 |
| K₁₁ | 6.6 | 6.6 | 6.6 | 6.6 | 6.6 |
| K₂₂ | 3.3 | 3.3 | 3.3 | 3.3 | 3.3 |
| K₃₃ | 17.6 | 17.6 | 17.6 | 17.6 | 17.6 |

### Verification Example 1: Example 1-1 to Example 1-7

In the present example, a preferable range of the twist angle θ₁ was examined in a case where the angle θₐ of the alignment direction a of the liquid crystal molecule 21A when no voltage was applied was 80°.

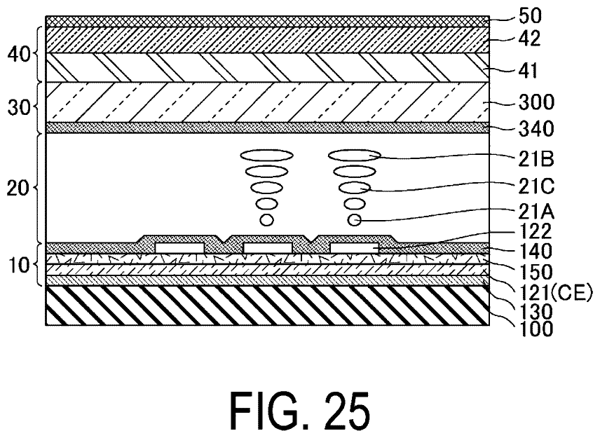

In the present example, the liquid crystal display device 1 according to the second embodiment was assumed as an FFS mode liquid crystal display device. FIG. 25 illustrates a schematic cross-sectional view of the liquid crystal display device 1 of the present example, and Table 2 shows specific optical settings. An angle of each axis means an angle of each axis when no voltage is applied in a case where the direction parallel to the gate wiring line GL is used as the reference (0°), and an angle rotated clockwise is a positive angle (+) and an angle rotated counterclockwise is a negative angle (−). In addition, in Table 2 (and Table 4 and Table 7), PI means a polyimide film as the horizontal alignment films 140 and 340. As the liquid crystal layer 20, a liquid crystal layer that performs normally black display in a monodomain structure was assumed, and a positive type liquid crystal material de5 was used as the liquid crystal material constituting the liquid crystal layer 20. The twist angle θ₁ was set to from 78° to 90°, and a VR curve and response characteristics were examined by using simulation software. The analysis results are shown in Table 3.

TABLE 2
Verification Example 1

| Polarizer | Absorption Axis Angle | | degrees | 11.2 |
|---|---|---|---|---|
| Phase | λ/2 Plate | Slow Axis | degrees | 30 |
| Difference | | Angle | | |
| Layer | | Phase | nm | 270 |
| | | Difference | | |
| | λ/4 Plate | Slow Axis | degrees | 54.6 |
| | | Angle | | |
| | | Phase | nm | 140 |
| | | Difference | | |
| Second | Glass | Thickness | μm | 300 |
| Substrate | PI | Film Thickness | μm | 0.1 |
| | | Dielectric | — | 3.5 |
| | | Constant | | |
| Liquid | Alignment Axis b of Liquid Crystal | | degrees | 163 |
| Crystal | Molecules 21B | | | |
| Layer | Cell Thickness | | μm | 3.17 |
| | dΔn | | μm | 243 |
| | Twist Angle | | degrees | 78 to 90 |
| | Alignment Axis a of Liquid Crystal | | degrees | 80 |
| | Molecules 21A | | | |
| First | PI | Film Thickness | μm | 0.1 |
| Substrate | | Dielectric | — | 3.5 |
| | | Constant | | |
| | Pixel Electrode | L/S | μm | 1.6/3.0 |
| | (ITO | Slit Angle | degrees | 90 |
| | Patterning) | Film Thickness | μm | 0.1 |
| | Interlayer | Film Thickness | μm | 0.22 |
| | Insulating | Dielectric | | |
| | Film | Constant | | |
| | (SiNx) | | — | 6.9 |
| | Common | Film Thickness | μm | 0.05 |
| | Electrode | | | |
| | (ITO Solid) | | | |
| | Reflective | Film Thickness | μm | 0.1 |
| | Layer | | | |
| | (Silver, | | | |
| | Aluminum) | | | |

TABLE 3

| | | | Example | Example | Example | Example | Example | Example | Example |
|---|---|---|---|---|---|---|---|---|---|
| | | | 1-1 | 1-2 | 1-3 | 1-4 | 1-5 | 1-6 | 1-7 |
| Twist Angle | | degrees | 78 | 82 | 83 | 86 | 87 | 88 | 90 |
| VR Curve | Black | % | 0.0198 | 0.0179 | 0.0183 | 0.0165 | 0.0158 | 0.0153 | 0.0147 |
| | Reflectivity | | | | | | | | |
| | Maximum | V | 5.0 | 5.2 | 4.0 | 4.2 | 4.0 | 4.0 | 4.2 |
| | Reflectivity | | | | | | | | |
| | Voltage | | | | | | | | |
| | Maximum | % | 38.1 | 38 | 38.4 | 38.4 | 38.4 | 38.4 | 38.4 |
| | Reflectivity | | | | | | | | |
| | Maximum | | PT | PT | RT | RT | RT | RT | RT |
| | Reflectivity | | | | | | | | |
| | Alignment | | | | | | | | |
| | CR | | 1919 | 2127 | 2098 | 2333 | 2430 | 2510 | 2613 |
| Response | tr (msec) | | — | — | 100% | 102.80% | 104.90% | 109.50% | 114.60% |
| Characteristics | td (msec) | | — | — | 100% | 100.20% | 100.40% | 100.60% | 100.90% |

In Table 3, the “maximum reflectivity voltage” and the “maximum reflectivity alignment” mean a voltage and an alignment state when the reflectivity exhibits the maximum value, respectively. Here, the reflectivity means a reflectivity of white display (also referred to as white reflectivity). In the row of the “maximum reflectivity alignment”, PT means a forward twist alignment and RT means a reverse twist alignment. The values described in the “response characteristics” row are values when each of the response speeds (tr, td; units thereof are msec) in Example 1-3 (in which the twist angle is 830) is set to 100%.

It can be seen from Table 3 that the reverse twist alignment is obtained when the twist angle θ₁ is equal to or more than 830. It can also be seen that a voltage at which the maximum reflectivity is exhibited is less than 5 V in the examples where the twist angle is equal to or more than 830. As a result, the twist angle is preferably equal to or more than 830. It can also be seen that when the twist angle is equal to or less than 870, the response characteristics fall within 105% when those in the case where the twist angle is 830 is defined as 100%. This range is an allowable range even if product variations occur at the time of completion of production. Thus, the twist angle is also preferably equal to or less than 87°. As described above, from the viewpoint of the maximum reflectivity, the maximum reflectivity voltage, and the response characteristics, it was found that the twist angle is particularly preferably equal to or more than 830 and equal to or less than 87°, and most preferably 83°.

### Verification Example 2: Example 2-1 to Example 2-6

In the present example, a preferable range of Δε of the liquid crystal material was examined when the angle θₐ of the alignment direction a of the liquid crystal molecules 21A when no voltage was applied was 80°.

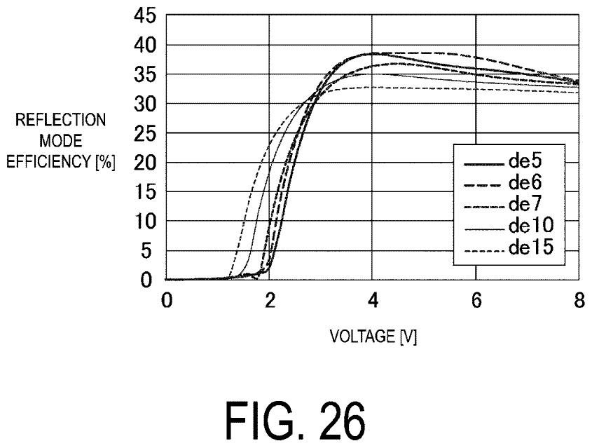

Also in the present example, the liquid crystal display device 1 according to the second embodiment was assumed as an FFS mode liquid crystal display device. FIG. 25 illustrates a schematic cross-sectional view of the liquid crystal display device 1 of the present example, and Table 4 shows specific optical settings. As the liquid crystal layer 20, a liquid crystal layer that performs normally black display in a monodomain structure was assumed, and a positive type liquid crystal material de5, de6, de7, de10, or de15 was used as a liquid crystal material constituting the liquid crystal layer 20. VR curves were calculated and analyzed by using simulation software. Results are provided in FIG. 26 to FIG. 29, and Table 5.

TABLE 4
Verification Example 2

| Polarizer | Absorption Axis Angle | | degrees | 11.2 |
|---|---|---|---|---|
| Phase | λ/2 Plate | Slow Axis | degrees | 30 |
| Difference | | Angle | | |
| Layer | | Phase | nm | 270 |
| | | Difference | | |
| | λ/4 Plate | Slow Axis | degrees | 54.6 |
| | | Angle | | |
| | | Phase | nm | 140 |
| | | Difference | | |
| Second | Glass | Thickness | μm | 300 |
| Substrate | PI | Film Thickness | μm | 0.1 |
| | | Dielectric | — | 3.5 |
| | | Constant | | |
| Liquid | Alignment Axis b of Liquid Crystal | | degrees | 163 |
| Crystal | Molecules 21B | | | |
| Layer | Cell Thickness | | μm | 3.17 |
| | dΔn | | μm | 235 |
| | Twist Angle | | degrees | 83 |
| | Alignment Axis a of Liquid Crystal | | degrees | 80 |
| | Molecules 21A | | | |
| First | PI | Film Thickness | μm | 0.1 |
| Substrate | | Dielectric | — | 3.5 |
| | | Constant | | |
| | Pixel Electrode | L/S | μm | 1.6/3.0 |
| | (ITO | Slit Angle | degrees | 90 |
| | Patterning) | Film Thickness | μm | 0.1 |
| | Interlayer | Film Thickness | μm | 0.22 |
| | Insulating Film | | | |
| | (SINx) | Dielectric | — | 6.9 |
| | | Constant | | |
| | Common | Film Thickness | μm | 0.05 |
| | Electrode | | | |
| | (ITO Solid) | | | |
| | Reflective | Film Thickness | μm | 0.1 |
| | Layer | | | |
| | (Silver, | | | |
| | Aluminum) | | | |

TABLE 5

| | | Example | Example | Example | Example | Example |
|---|---|---|---|---|---|---|
| | | 2-1 | 2-2 | 2-3 | 2-4 | 2-5 |
| Liquid | | de5 | de6 | de7 | de10 | de15 |
| Crystal | | | | | | |
| Material No. | | | | | | |
| VRmax | V | 4.0 | 4.4 | 4.4 | 4.0 | 4.0 |
| Rmax | % | 38.4 | 38.7 | 36.7 | 34.9 | 32.8 |

FIG. 26 is a graph illustrating reflection mode efficiency when each of the liquid crystal materials is used. In FIG. 26, the horizontal axis represents an applied voltage (V) to the liquid crystal layer 20, and the vertical axis represents the reflection mode efficiency (%). The obtained curve is referred to as a VR curve. Table 5 summarizes the results based on FIG. 26. In Table 5, “VRmax” means a voltage at which the reflection mode efficiency indicates the maximum value, and “Rmax” means the maximum value of the reflection mode efficiency.

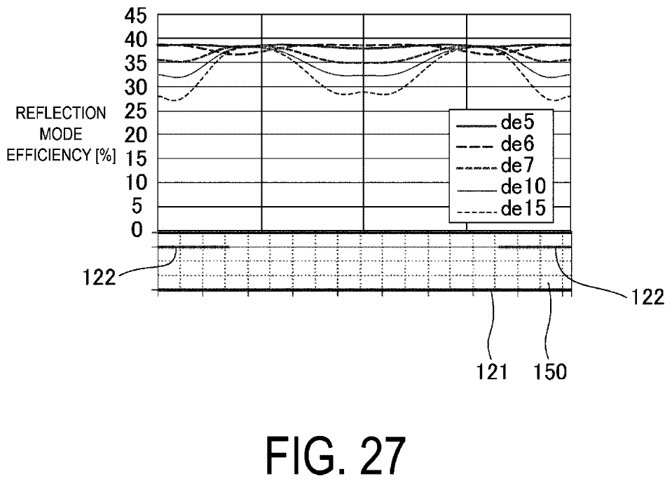

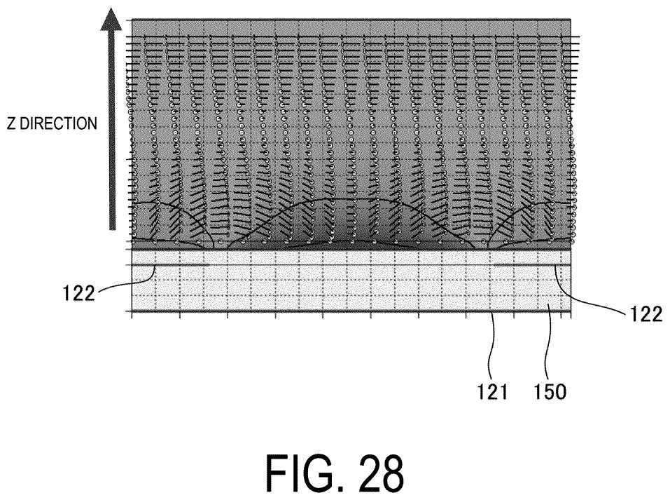

FIG. 27 is a diagram (referred to as a reflectivity profile) obtained by analyzing the VR curves illustrated in FIG. 26, focusing on the liquid crystal director when a voltage is applied. As a result of analyzing the reflectivity profile at the voltage (that is, VRmax) at which the reflection mode efficiency exhibits the maximum value, it was found that the reflectivity in the central portion between the first electrode 121 (CE) and the second electrode 122 (PE) decreases as Δε increases (see FIG. 27). In order to consider the reason why the reflectivity profiles have such a difference between the high value and the low value, the average azimuth angle φLCave and the polar angle of the liquid crystal molecules at VRmax were analyzed (see FIG. 28).

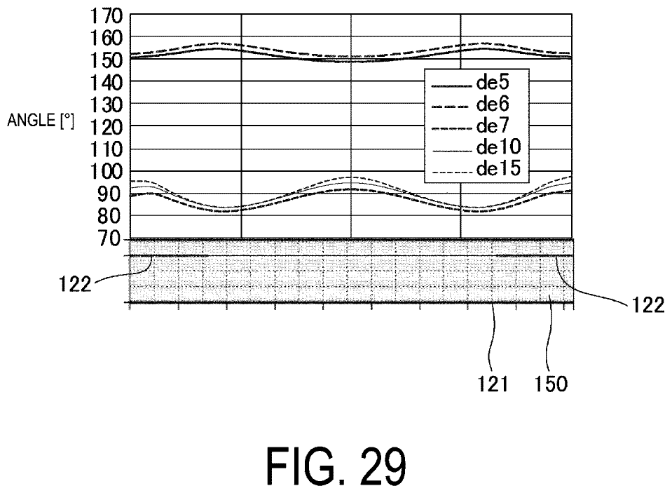

FIG. 28 is a reflectivity profile (cross-sectional view) at VRmax. The vertical axis represents a distance of the liquid crystal layer 20 from the first substrate 10 in the thickness direction (also referred to as the Z direction) (a distance is larger toward the top of the drawing, that is, the liquid crystal substrate 20 is closer to the second substrate 30). Based on FIG. 28, an average value of the liquid crystal director in the thickness direction was analyzed. Specifically, since the liquid crystal display device 1 of the present example is in the FFS mode (transverse electrical field), azimuth angles of the liquid crystal molecules 21 were analyzed. The results are illustrated in FIG. 29. FIG. 29 is an analysis result of the average azimuth angle φLCave of the liquid crystal molecules in the Z direction. In FIG. 29, the vertical axis represents the average azimuth angle φLCave of the liquid crystal molecules 21.

In particular, from FIG. 27 and FIG. 29, the following matters were found.

First, it was found that the average azimuth angle φLCave varies depending on whether Δε of the liquid crystal molecules is equal to or less than 7 or exceeds 7. Additionally, an example in which the white reflectivity is high and the reflectivity profile is nearly uniform is an example in which the liquid crystal material having Δε being equal to or less than 7 is used. In this case, the average azimuth angle is around 150°, and the alignment of the liquid crystal molecules is close to homogeneous. That is, in these examples, the reverse twist alignment is obtained (see FIG. 9B). On the other hand, an example in which the white reflectivity is low and the reflectivity profile has high and low values and is non-uniform is an example in which the liquid crystal material having Δε exceeding 7 is used. In this case, the average azimuth angle φLCave is around 90°, and the alignment of the liquid crystal molecules is more twisted. That is, in these examples, the forward twist alignment is obtained (see FIG. 11B).

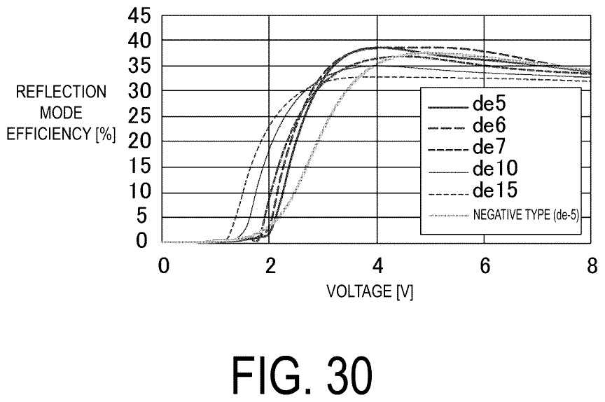

The above results are summarized in Table 6. In Example 2-6, as a reference example, a simulation result obtained by using a negative type liquid crystal material, instead of the positive type liquid crystal material, is also shown. Moreover, FIG. 30 is a graph obtained by adding the VR curve of Example 2-6 (that is, the VR curve obtained when the negative type liquid crystal material (de-5) is used) to the graph of FIG. 26.

TABLE 6

| | | Example | Example | Example | Example | Example | Example |
|---|---|---|---|---|---|---|---|
| | | 2-1 | 2-2 | 2-3 | 2-4 | 2-5 | 2-6 |
| Liquid Crystal | | de5 | de6 | de7 | de10 | de15 | Negative |
| Material No. | | | | | | | type |
| Δε | | 5.3 | 6.3 | 7.3 | 10.3 | 15.3 | −5.0 |
| Alignment | | RT | RT | PT | PT | PT | RT |
| VRmax | V | 4.0 | 4.0 | 4.4 | 4.0 | 4.0 | 5.0 |
| Rmax | % | 38.4 | 38.7 | 36.7 | 34.9 | 32.8 | 37.4 |
| φLCave | degrees | 151.7 | 153.8 | 86.8 | 88.9 | 90.1 | −106.8 |

In Table 6, the “alignment” means an alignment state when the white reflectivity exhibits the maximum value, PT means the forward twist alignment, and RT means the reverse twist alignment.

From Table 6, the following matters were found.

Among the examples in which the positive type liquid crystal material was used, in Example 2-3 to Example 2-5 in which the liquid crystal material having Δε exceeding 7 was used, the forward twist alignment was obtained when a white voltage was applied, and the maximum reflectivity (Rmax) was from 32.8% to 36.7%. In Example 2-6 in which the negative type liquid crystal material was used, the reverse twist alignment was obtained, and the maximum reflectivity (Rmax) was 37.4%, which was higher than those in Examples 2-3 to 2-5. As a result of further analysis, it was found that in examples using the positive type liquid crystal material having Δε being equal to or less than 7 such as Example 2-1 and Example 2-2, the reverse twist alignment is obtained and the maximum reflectivity (Rmax) is higher than that in Example 2-6 using the negative type liquid crystal material. Note that in general, when the absolute value of Δε is less than 2, an anisotropy of dielectric constant is not exhibited, and thus a lower limit value of Δε is particularly preferably equal to or more than 3.

Incidentally, it is considered that a drive voltage (white voltage) is preferably less than 5 V from the viewpoint of further achieving lower power consumption that is an advantage of the reflection type. However, in the case of using the negative type liquid crystal material, Δε of polar components cannot be made larger than that of the positive type liquid crystal material because of its structure, and it is not realistic to make the absolute value of Δε equal to or more than 7, for example. Even when the liquid crystal material having a high value of Δε such as Δε=−7 is used, a trade-off problem occurs such that a response speed is delayed due to an increase in viscosity of the liquid crystal layer or a VHR is decreased due to an increase in possibility of taking in impurity ions. On the other hand, in the examples using the positive type liquid crystal material having Δε equal to or less than 7 as in Example 2-1 and Example 2-2, a drive voltage can be set to be equal to or less than 5 V, and lower power consumption can be achieved.

Thus, it was found that Δε of the liquid crystal material is particularly preferably equal to or more than 3 and equal to or less than 7 from the viewpoint of achieving the drive voltage less than 5 V, obtaining a higher reflectivity than that in the case of using the negative type liquid crystal material, and achieving the reverse twist alignment. In addition, it was also found that the average azimuth angle φLCave of the liquid crystal molecules in the reverse twist alignment in the case of using the positive type liquid crystal material is particularly preferably equal to or more than 1510 and equal to or less than 154°.

### Verification Example 3: Example 3-1 to Example 3-11

From Verification Example 2, it was found that further enhancement of the white reflectivity is caused by the reverse twist alignment at the time of the white display. Thus, in the present example, the physical properties of the liquid crystal material were further examined.

Also in the present example, the liquid crystal display device 1 according to the second embodiment was assumed as an FFS mode liquid crystal display device. FIG. 25 illustrates a schematic cross-sectional view of the liquid crystal display device 1 of the present example, and Table 7 shows specific optical settings. As the liquid crystal layer 20, a liquid crystal layer that performs normally black display in a monodomain structure was assumed, and a positive type liquid crystal material or a negative type liquid crystal material was used as a liquid crystal material constituting the liquid crystal layer 20. VR curves were calculated and analyzed by using simulation software.

TABLE 7
Verification Example 3

| Polarizer | Absorption Axis Angle | | degrees | 11.2 |
|---|---|---|---|---|
| Phase | λ/2 Plate | Slow Axis | degrees | 30 |
| Difference | | Angle | | |
| Layer | | Phase | nm | 270 |
| | | Difference | | |
| | λ/4 Plate | Slow Axis | degrees | 54.6 |
| | | Angle | | |
| | | Phase | nm | 140 |
| | | Difference | | |
| Second | Glass | Thickness | μm | 300 |
| Substrate | PI | Film Thickness | μm | 0.1 |
| | | Dielectric | — | 3.5 |
| | | Constant | | |
| Liquid | Alignment Axis b of Liquid Crystal | | degrees | 163 |
| Crystal | Molecules 21B | | | |
| Layer | Cell Thickness | | μm | 3.17 |
| | dΔn | | μm | 243 |
| | Twist Angle | | degrees | 83 |
| | Alignment Axis a of Liquid Crystal | | degrees | 80 |
| | Molecules 21A | | | |
| First | PI | Film Thickness | μm | 0.1 |
| Substrate | | Dielectric | — | 3.5 |
| | | Constant | | |
| | Pixel Electrode | L/S | μm | 1.6/3.0 |
| | (ITO Patterning) | Slit Angle | degrees | 90 |
| | | Film Thickness | μm | 0.1 |
| | Interlayer | Film Thickness | μm | 0.22 |
| | Insulating | Dielectric | — | 6.9 |
| | Film (SINx) | Constant | | |
| | Common Electrode | Film Thickness | μm | 0.05 |
| | (ITO Solid) | | | |
| | Reflective Layer | Film Thickness | μm | 0.1 |
| | (Silver, Aluminum) | | | |

It is considered that when a white voltage is applied, the electrical field behavior of an orientation of the liquid crystal director varies depending on a torque balance between Δε and a twist elastic constant K₂₂. For this reason, a difference in Δεg or K₂₂ was focused and analyzed. The results of analysis focusing on the difference in Δεg are shown in Table 8, and the results of analysis focusing on the difference in K₂₂ are shown in Table 9.

TABLE 8

| | | Example | Example | Example | Example | Example | Example |
|---|---|---|---|---|---|---|---|
| | | 3-1 | 3-2 | 3-3 | 3-4 | 3-5 | 3-6 |
| Δn | | 0.077 | 0.077 | 0.077 | 0.077 | 0.077 | 0.077 |
| Δε | | 15.3 | 10.3 | 7.3 | 6.3 | 5.3 | −5.0 |
| K₁₁ | pN | 6.6 | 6.6 | 6.6 | 6.6 | 6.6 | 13.7 |
| K₂₂ | pN | 3.3 | 3.3 | 3.3 | 3.3 | 3.3 | 6.8 |
| K₃₃ | pN | 17.6 | 17.6 | 17.6 | 17.6 | 17.6 | 14 |
| d (μm) | μm | 3.17 | 3.17 | 3.17 | 3.17 | 3.17 | 3.17 |
| Alignment | | PT | PT | PT | RT | RT | RT |
| VRmax | V | 4.0 | 4.0 | 4.4 | 4.4 | 4.0 | 5.0 |
| Rmax | % | 32.8 | 34.9 | 36.7 | 38.7 | 38.4 | 37.5 |
| φLCave | degrees | 90.1 | 88.9 | 86.8 | 153.1 | 151.7 | −106.8 |

TABLE 9

| | | Example | Example | Example | Example | Example |
|---|---|---|---|---|---|---|
| | | 3-7 | 3-8 | 3-9 | 3-10 | 3-11 |
| Δn | | 0.077 | 0.077 | 0.077 | 0.077 | 0.077 |
| Δε | | 15.3 | 15.3 | 15.3 | 7.3 | 10.3 |
| K₁₁ | pN | 6.6 | 6.6 | 6.6 | 13.2 | 13.2 |
| K₂₂ | pN | 3.3 | 6.6 | 10 | 6.6 | 6.6 |
| K₃₃ | pN | 17.6 | 17.6 | 17.6 | 17.6 | 17.6 |
| d (μm) | μm | 3.17 | 3.17 | 3.17 | 3.17 | 3.17 |
| Alignment | | PT | PT | PT | PT | PT |
| VRmax | V | 4.0 | 6.4 | 7.8 | 6.8 | 6.4 |
| Rmax | % | 32.8 | 34.6 | 35.4 | 36.6 | 35.7 |
| φLCave | degrees | 90.1 | 84.4 | 81.8 | 83.3 | 84.1 |

From Table 8 and Table 9, it was found that when the positive type liquid crystal material was used, the reverse twist alignment was obtained and moreover, the white reflectivity was higher than that when the negative type liquid crystal material was used, in the examples in which Δε was equal to or less than 7 and K₂₂ was equal to or less than 6. In addition, when an absolute value of Δε is less than 2, an optical change due to the liquid crystal and the anisotropy of dielectric constant is slight and a high voltage can be obtained, and thus a lower limit value of Δε is particularly preferably equal to or more than 3. When an absolute value of K₂₂ is less than 2, a rise of response characteristics may be delayed, so that a lower limit value of K₂₂ is particularly preferably equal to or more than 3.

In summary, it was found that in order to achieve the reverse twist alignment using the positive type liquid crystal material, Δε of the liquid crystal material is particularly preferably equal to or more than 3 and equal to or less than 7, and K₂₂ of the liquid crystal material is particularly preferably equal to or more than 3 and equal to or less than 6. It was also found that the average azimuth angle φLCave of the liquid crystal molecules is particularly preferably equal to or more than 1510 and equal to or less than 154°.

### Verification Example 4: Example 4-1 to Example 4-10

As described above, it is considered that the cause of the forward twist alignment or the reverse twist alignment is the fact that the behavior of the liquid crystal molecules differs depending on whether or not equipotential lines reach the counter substrate (second substrate 30) near a threshold voltage. Therefore, when the retardation dΔn of the liquid crystal layer 20 was fixed, and not only which of an example having a large cell thickness and an example having a small cell thickness takes the reverse twist alignment, but also physical properties of the liquid crystal material in each of the examples were investigated.

Also in the present example, the liquid crystal display device 1 according to the second embodiment was assumed as an FFS mode liquid crystal display device. FIG. 25 illustrates a schematic cross-sectional view of the liquid crystal display device 1 of the present example, and Table 7 shows specific optical settings (similar to Verification Example 3). As the liquid crystal layer 20, a liquid crystal layer that performs normally black display in a monodomain structure was assumed, and a positive type liquid crystal material was used as the liquid crystal material constituting the liquid crystal layer 20. VR curves were calculated and analyzed by using simulation software.

Table 10 shows analysis results of an example in which the cell thickness d is 4.05 μm and the birefringence index Δn of the liquid crystal material is 0.06 as the example in which the cell thickness is large. Table 11 shows analysis results of an example in which the cell thickness d is 2.70 μm and the birefringence index Δn of the liquid crystal material is 0.09 as the example in which the cell thickness is small.

TABLE 10

| | | Example | Example | Example | Example | Example |
|---|---|---|---|---|---|---|
| | | 4-1 | 4-2 | 4-3 | 4-4 | 4-5 |
| Δn | | 0.06 | 0.06 | 0.06 | 0.06 | 0.06 |
| Δε | | 15.3 | 10.3 | 7.3 | 6.3 | 5.3 |
| K₁₁ | pN | 6.6 | 6.6 | 6.6 | 6.6 | 6.6 |
| K₂₂ | pN | 3.3 | 3.3 | 3.3 | 3.3 | 3.3 |
| K₃₃ | pN | 17.6 | 17.6 | 17.6 | 17.6 | 17.6 |
| d (μm) | μm | 4.05 | 4.05 | 4.05 | 4.05 | 4.05 |
| Alignment | | PT | PT | PT | PT | PT |
| VRmax | V | 3.6 | 4.0 | 4.6 | 5.0 | 5.4 |
| Rmax | % | 32 | 34.8 | 37 | 37.8 | 38.2 |
| φLCave | degrees | 92.5 | 89.7 | 86.6 | 84.8 | 83.4 |

TABLE 11

| | | Example | Example | Example | Example | Example |
|---|---|---|---|---|---|---|
| | | 4-6 | 4-7 | 4-8 | 4-9 | 4-10 |
| Δn | | 0.09 | 0.09 | 0.09 | 0.09 | 0.09 |
| Δε | | 15.3 | 10.3 | 7.3 | 6.3 | 5.3 |
| K₁₁ | pN | 6.6 | 6.6 | 6.6 | 6.6 | 6.6 |
| K₂₂ | pN | 3.3 | 3.3 | 3.3 | 3.3 | 3.3 |
| K₃₃ | pN | 17.6 | 17.6 | 17.6 | 17.6 | 17.6 |
| d (μm) | μm | 2.7 | 2.7 | 2.7 | 2.7 | 2.7 |
| Alignment | | RT | RT | RT | RT | RT |
| VRmax | V | 3.6 | 3.8 | 4.0 | 4.2 | 4.2 |
| Rmax | % | 36.5 | 37.8 | 38.2 | 38.2 | 38.3 |
| φLCave | degrees | 148.0 | 150.1 | 151.5 | 152.1 | 151.8 |

From Table 10 and Table 11, it was found that the reverse twist alignment can be achieved by using the positive type liquid crystal material in Examples 4-6 to 4-10 in which the cell thickness is small (d=2.70 μm), and among these Examples, reflectivities are higher than those in the case of using the negative type liquid crystal material (for example, see Example 2-6, Example 3-6, and the like), in Example 4-7 to Example 4-10 in which Δε is equal to or less than 15. In Example 4-1 to Example 4-5 in which the cell thickness is large (d=4.05 μm), it was found that regardless of a value of Δε, the forward twist alignment is taken in all cases, and it was also found that Rmax is lower than that in the case where the negative type liquid crystal material is used, or VRmax is a high voltage value equal to or higher than 5 V.

Thus, it was found that the birefringence index Δn of the liquid crystal material is particularly preferably equal to or more than 0.077 and equal to or less than 0.09 from the viewpoints that the reverse twist alignment can be achieved and a higher reflectivity can be obtained than those in the case of using the negative type liquid crystal material. It was also found that the average azimuth angle φLCave of the liquid crystal molecules is preferably equal to or more than 150° and equal to or less than 156°, more preferably equal to or more than 150° and equal to or less than 155°, and most preferably equal to or more than 1510 and equal to or less than 1530.

Based on all of Table 8 to Table 11, it was found that when the angle θₐ of the alignment direction a of the liquid crystal molecules 21A on the first substrate 10 side when no voltage is applied is 80°, the anisotropy of dielectric constant Δε, the birefringence index Δn, and the twist elastic constant K₂₂ of the liquid crystal material are most preferably 3≤Δε≤7, 0.077≤Δn≤0.09, and 3≤K₂₂≤6, respectively. It was also found that the average azimuth angle φLCave of the liquid crystal material is most preferably 151°≤φLCave≤153°.

### Verification Example 5: Example 5-1 to Example 5-6

Next, in the case where the angle θₐ of the alignment direction a of the liquid crystal molecules 21A when no voltage was applied was 83°, a preferable range of the twist angle θ₁ was examined.

In the present example, the VR curve and the response characteristics were studied by using simulation software under the same conditions as those in Verification Example 1 (see Table 2 described above) except that θₐ was 83°. The results are shown in Table 12. For reference, the results and the like of Example 1-3 are also shown. The values shown in rows of the “response characteristics” are values when each of the response speeds in Example 1-3 (in which the twist angle is 83°) is set to 100%.

TABLE 12

| | | | Example | Example | Example | Example | Example | Example |
|---|---|---|---|---|---|---|---|---|
| | | | 1-3 | 5-1 | 5-3 | 5-4 | 5-5 | 5-6 |
| Twist Angle | | degrees | 83 | 78 | 83 | 86 | 88 | 90 |
| VR Curve | Black | % | 0.0183 | 0.019841 | 0.0183 | 0.0165 | 0.0153 | 0.0147 |
| | Reflectivity | | | | | | | |
| | Maximum | V | 4.0 | 4.4 | 4.4 | 4.4 | 4.4 | 4.4 |
| | Reflectivity | | | | | | | |
| | Voltage | | | | | | | |
| | Maximum | % | 38.4 | 38.4 | 38.4 | 38.4 | 38.4 | 38.4 |
| | Reflectivity | | | | | | | |
| | Maximum | | RT | RT | RT | RT | RT | RT |
| | Reflectivity | | | | | | | |
| | Alignment | | | | | | | |
| | CR | | 2098 | 1934 | 2097 | 2334 | 2510 | 2609 |
| Response | tr (msec) | | 100% | 83.0% | 90.0% | 92.2% | 94.0% | 96.4% |
| Characteristics | td (msec) | | 100% | 100.8% | 97.5% | 102.4% | 102.4% | 102.8% |

From Table 12, it was found that when θₐ is 83°, the reverse twist alignment is taken and the voltage at which the maximum reflectivity is exhibited is less than 5 V in the entire range (from 78° to 90°) of the calculated twist angle θ₁. In the above range, it was found that the twist angle θ₁ is particularly preferably equal to or more than 78′ and equal to or less than 88°, more preferably equal to or more than 83′ and equal to or less than 87°, and most preferably 83′ from the viewpoints of the maximum reflectivity, the maximum reflectivity voltage, and the response characteristics. In addition, the maximum reflectivity voltage is lower in the example in which θₐ is 80° (Example 1-3) than in the examples in which θₐ is 83′ (Example 5-1 to Example 5-5). Thus, it was also found that θₐ is more preferably 80° than 83′ from the viewpoint of achieving lower power consumption.

### Verification Example 6: Example 6-1 to Example 6-11

Next, when θₐ was 83°, the physical properties of the liquid crystal material were further examined in a similar manner to that in Verification Example 3 described above.

In the present example, the same conditions as those in Verification Example 3 (see Table 7 shown above) were set except that θₐ was 83°, and the VR curve was calculated and analyzed by using simulation software. The results of analysis focusing on a difference in Δε are shown in Table 13, and the results of analysis focusing on a difference in K₂₂ are shown in Table 14.

TABLE 13

| | | Example | Example | Example | Example | Example | Example |
|---|---|---|---|---|---|---|---|
| | | 6-1 | 6-2 | 6-3 | 6-4 | 6-5 | 6-6 |
| Δn | | 0.0766 | 0.0766 | 0.0766 | 0.0766 | 0.0766 | 0.0779 |
| Δε | | 15.3 | 10.3 | 7.3 | 6.3 | 5.3 | −5.0 |
| K₁₁ | pN | 6.6 | 6.6 | 6.6 | 6.6 | 6.6 | 13.7 |
| K₂₂ | pN | 3.3 | 3.3 | 3.3 | 3.3 | 3.3 | 6.8 |
| K₃₃ | pN | 17.6 | 17.6 | 17.6 | 17.6 | 17.6 | 14 |
| d (μm) | μm | 3.17 | 3.17 | 3.17 | 3.17 | 3.17 | 2.36 |
| Alignment | | RT | RT | RT | RT | RT | RT |
| VRmax | V | 3.8 | 4.0 | 4.0 | 4.2 | 4.2 | 5.4 |
| Rmax | % | 36.6 | 37.8 | 38.3 | 38.4 | 38.4 | 37.4 |
| φLCave | degrees | 150.7 | 153.2 | 154.3 | 155.0 | 154.7 | −104.7 |

TABLE 14

| | | Example | Example | Example | Example | Example |
|---|---|---|---|---|---|---|
| | | 6-7 | 6-8 | 6-9 | 6-10 | 6-11 |
| Δn | | 0.0766 | 0.0766 | 0.0766 | 0.0766 | 0.0766 |
| Δε | | 15.3 | 15.3 | 15.3 | 7.3 | 10.3 |
| K₁₁ | pN | 6.6 | 13.2 | 20 | 13.2 | 13.2 |
| K₂₂ | pN | 3.3 | 6.6 | 10 | 6.6 | 6.6 |
| K₃₃ | pN | 17.6 | 17.6 | 17.6 | 17.6 | 17.6 |
| d (μm) | μm | 3.17 | 3.17 | 3.17 | 3.17 | 3.17 |
| Alignment | | RT | RT | RT | RT | RT |
| VRmax | V | 3.8 | 4.8 | 5.4 | 5.4 | 5.0 |
| Rmax | % | 36.6 | 36.9 | 36.9 | 37.7 | 37.4 |
| φLCave | degrees | 150.7 | 151.9 | 152.4 | 153.7 | 152.8 |

From Table 13 and Table 14, it was found that Δε of the liquid crystal material is particularly preferably equal to or more than 3 and equal to or less than 15, and most preferably equal to or more than 3 and equal to or less than 10, and K₂₂ of the liquid crystal material is particularly preferably equal to or more than 3 and equal to or less than 5, from the viewpoints that the reverse twist alignment can be achieved and a higher reflectivity can be obtained than those in the case of using the negative type liquid crystal material. It was also found that the average azimuth angle φLCave of the liquid crystal molecules is particularly preferably equal to or more than 151° and equal to or less than 156°.

### Verification Example 7: Example 7-1 to Example 7-10

Next, in the case where θₐ was 83°, the physical properties of the liquid crystal material were further examined in a similar manner to that in Verification Example 4.

In the present example, the same conditions as those in Verification Example 4 (see Table 7 shown above) were set except that θₐ was 83°, and VR curves were calculated and analyzed by using simulation software. Table 15 shows the results of analysis of an example in which the cell thickness d is 4.05 μm and the birefringence index Δn of the liquid crystal material is 0.06, for example, as the example in which the cell thickness is large. Table 16 shows the analysis results of an example in which the cell thickness d is 2.70 μm and the birefringence index Δn of the liquid crystal material is 0.09, for example, as an example in which the cell thickness is small.

TABLE 15

| | | Example | Example | Example | Example | Example |
|---|---|---|---|---|---|---|
| | | 7-1 | 7-2 | 7-3 | 7-4 | 7-5 |
| Δn | | 0.06 | 0.06 | 0.06 | 0.06 | 0.06 |
| Δε | | 15.3 | 10.3 | 7.3 | 6.3 | 5.3 |
| K₁₁ | pN | 6.6 | 6.6 | 6.6 | 6.6 | 6.6 |
| K₂₂ | pN | 3.3 | 3.3 | 3.3 | 3.3 | 3.3 |
| K₃₃ | pN | 17.6 | 17.6 | 17.6 | 17.6 | 17.6 |
| d (μm) | μm | 4.1 | 4.1 | 4.1 | 4.1 | 4.1 |
| Alignment | | RT | RT | RT | RT | RT |
| VRmax | V | 3.6 | 3.8 | 3.8 | 4.0 | 4.0 |
| Rmax | % | 37.9 | 38.3 | 38.5 | 38.5 | 38.5 |
| φLCave | degrees | 151.5 | 153.8 | 154.9 | 155.3 | 155.0 |

TABLE 16

| | | Example | Example | Example | Example | Example |
|---|---|---|---|---|---|---|
| | | 7-6 | 7-7 | 7-8 | 7-9 | 7-10 |
| Δn | | 0.09 | 0.09 | 0.09 | 0.09 | 0.09 |
| Δε | | 15.3 | 10.3 | 7.3 | 6.3 | 5.3 |
| K₁₁ | pN | 6.6 | 6.6 | 6.6 | 6.6 | 6.6 |
| K₂₂ | pN | 3.3 | 3.3 | 3.3 | 3.3 | 3.3 |
| K₃₃ | pN | 17.6 | 17.6 | 17.6 | 17.6 | 17.6 |
| d (μm) | μm | 2.7 | 2.7 | 2.7 | 2.7 | 2.7 |
| Alignment | | RT | RT | RT | RT | RT |
| VRmax | V | 3.8 | 4.0 | 4.2 | 4.4 | 4.4 |
| Rmax | % | 35.9 | 37.4 | 38.1 | 38.2 | 38.3 |
| φLCave | degrees | 150.1 | 152.4 | 154.1 | 154.8 | 154.6 |

From Table 15 and Table 16, it was found that the birefringence index Δn of the liquid crystal material is particularly preferably equal to or more than 0.06 and equal to or less than 0.09 from the viewpoints that the reverse twist alignment can be achieved and a higher reflectivity can be obtained than those in the case of using the negative type liquid crystal material. It was also found that the average azimuth angle φLCave of the liquid crystal molecules is particularly preferably equal to or more than 151° and equal to or less than 156°.

From all of Table 13 to Table 16, it was found that when the angle θₐ of the alignment direction a of the liquid crystal molecules 21A on the first substrate 10 side when no voltage is applied is 83°, the anisotropy of dielectric constant Δε, the birefringence index Δn, and the twist elastic constant K₂₂ of the liquid crystal material are most preferably 3≤Δε≤10, 0.06≤Δn≤0.09, and 3≤K₂₂≤5, respectively. It was also found that the average azimuth angle φLCave of the liquid crystal material is most preferably 151°≤φLCave≤156°.

### Verification Example 8: Example 8-1 to Example 8-5

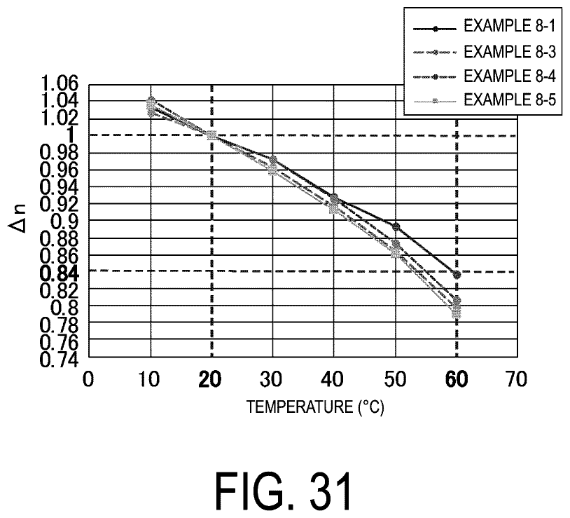

The black display is achieved by compensating, at the phase difference layer, the λ/4 condition determined by the retardation dΔn of the liquid crystal layer (that is, the product of the thickness d of the liquid crystal layer 20 and the birefringence index Δn of the liquid crystal material) and the twist alignment. However, the birefringence index Δn of the liquid crystal material has a temperature characteristic in which Δn decreases as the temperature increases. In general, in a display mode in which the black display is performed by compensating the retardation of the liquid crystal layer at the phase difference layer, in order to improve the temperature characteristic of Δn, a countermeasure is often taken by increasing Tni (a nematic-isotropic phase transition temperature) of the liquid crystal material (for example, an Optically Compensated Bend (OCB) mode, or the like). However, when Tni is increased, the elastic constant may also be increased in conjunction therewith, and in this case, there is a concern that the VT and VR curves may be increased in voltage. In order to improve this, it is conceivable to increase Δε. However, when Δε is increased, the viscosity is also increased, so that the response becomes slow, and thus optical characteristics of a display are not optimal in some cases. Thus, in order to improve the temperature characteristic of Δn while minimizing the increase in Tni of the liquid crystal material, the present inventors of the disclosure focused on a ratio (Δn₆₀/Δn₂₀) between the birefringence index Δn₆₀ at 60° C. and the birefringence index Δn₂₀ at 20° C., and compared and studied the temperature characteristics of Δn of various liquid crystal materials. The results are illustrated in FIG. 31 to FIG. 34 and shown in Table 17.

Note that the configurations, of the liquid crystal display device, other than the liquid crystal material, the optical settings, and the like were the same as those in Verification Example 5. That is, the same conditions as those in Verification Example 1 (see Table 2 shown above) were set except that θₐ was 83°.

TABLE 17

| | | Example | Example | Example | Example | Example |
|---|---|---|---|---|---|---|
| | | 8-1 | 8-2 | 8-3 | 8-4 | 8-5 |
| Δn₂₀ | | 0.0710 | 0.072 | 0.0698 | 0.0753 | 0.0762 |
| Δn₆₀ | | 0.0596 | 0.0613 | 0.0555 | 0.0607 | 0.0602 |
| Δn₆₀/Δn₂₀ | | 83.9% | 85.2% | 79.5% | 80.6% | 79.0% |
| Black Floating | | Good | Good | Poor | Poor | Poor |
| at 50° C. | | | | | | |
| Contrast | 20° C. | 30 | 30 | 34 | 33 | 33 |
| | 50° C. | 28 | 28 | 12 | 13 | 13 |

FIG. 31 is a graph obtained by examining the temperature characteristics of Δn of various liquid crystal materials. In this graph, for each liquid crystal material, the birefringence index Δn₂₀ at each temperature of 10° C., 20° C., 30° C., 40° C., 50° C., and 60° C. is plotted when the birefringence index Δn₂₀ at 20° C. is defined as 1. The horizontal axis represents a temperature, and the vertical axis represents a birefringence index Δn (provided that the birefringence index Δn₂₀ at 20° C. is defined as 1). The birefringence index Δn is a value at a wavelength of 550 nm.

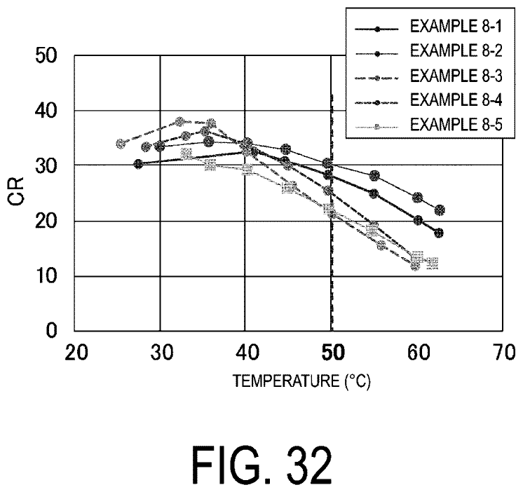

FIG. 32 is a graph obtained by examining temperature dependence of contrast. That is, VR curves were calculated and analyzed by simulation software. The horizontal axis represents a temperature, and the vertical axis represents contrast (CR; that is, a ratio of reflection mode efficiency in the white display to reflection mode efficiency in the black display).

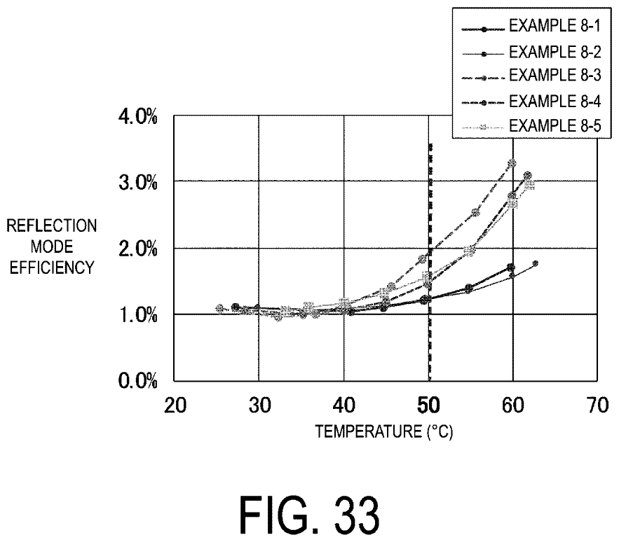

FIG. 33 is a graph obtained by examining temperature dependence of reflection mode efficiency in the black display. That is, VR curves were calculated and analyzed by simulation software. The horizontal axis represents a temperature, and the vertical axis represents reflection mode efficiency in the black display (that is, when no voltage is applied).

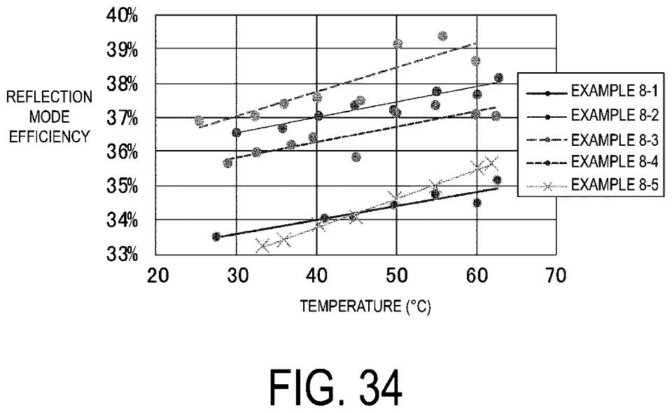

FIG. 34 is a graph obtained by examining temperature dependence of reflection mode efficiency in the white display. That is, VR curves were calculated and analyzed by simulation software. The horizontal axis represents a temperature, and the vertical axis represents reflection mode efficiency in the white display (when a voltage of 5 V is applied).

Assuming that a temperature range of the liquid crystal panel in actual use was equal to or less than 50° C., the presence or absence of black floating at 50° C. was also evaluated in Table 17. The black floating was evaluated as follows.

### Evaluation Method

The black display state when each of the produced liquid crystal display devices was heated to 50° C. was actually visually observed and evaluated according to the following criteria.

Good: No problem in actual use.

Poor: Contrast reduction was observed after heating, and commercial value was lacking.

From Table 17 and FIG. 31 to FIG. 34, it was found that when the ratio (Δn₆₀/Δn₂₀) of the birefringence index Δn₆₀ at 60° C. to the birefringence index Δn₂₀ at 20° C. is equal to or more than 0.84, display without black floating at 50° C., that is, display without temperature change even at 50° C., which is a general temperature in actual use, can be obtained. Note that the present inventors have already substantiated that there is no significant decrease in contrast when the ratio (Δn₆₀/Δn₂₀) described above is equal to or less than 1.1.

Each aspect of the disclosure described above may be combined as appropriate without departing from the gist of the disclosure.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal display device including a plurality of pixels, the liquid crystal display device comprising:
a first substrate;
a second substrate facing the first substrate; and
a liquid crystal layer provided between the first substrate and the second substrate,
wherein the first substrate includes a reflective layer configured to reflect light, a first electrode and a second electrode configured to generate a transverse electrical field in the liquid crystal layer, and a first horizontal alignment film being in contact with the liquid crystal layer,
an electrode, of the first electrode and the second electrode, disposed on a side of the liquid crystal layer includes a plurality of belt-shaped portions and a slit positioned between two adjacent belt-shaped portions of the plurality of belt-shaped portions,
each of the plurality of belt-shaped portions has a linear shape extending substantially parallel to each other and in an identical direction,
the liquid crystal layer is constituted by a liquid crystal material including a liquid crystal molecule,
the liquid crystal material is a positive type,
the second substrate includes a second horizontal alignment film being in contact with the liquid crystal layer,
the liquid crystal layer takes a twist alignment when no voltage is applied, and a twist angle is equal to or more than 780 and equal to or less than 90° when no voltage is applied,
the extending direction of the plurality of belt-shaped portions is positioned between a long axis direction of a liquid crystal molecule, of a plurality of the liquid crystal molecules, on a side of the first substrate and a long axis direction of a liquid crystal molecule, of the plurality of liquid crystal molecules, on a side of the second substrate at least in a central portion of the liquid crystal layer in a plane direction in a plan view of the liquid crystal layer of each of the plurality of pixels when no voltage is applied, and
when a voltage is applied, at least a liquid crystal molecule, of the plurality of liquid crystal molecules, positioned in a central portion of the liquid crystal layer in a thickness direction is rotated, in a twist direction when no voltage is applied, in the plan view of the liquid crystal layer of each of the plurality of pixels.

2. The liquid crystal display device according to claim 1,
wherein a product (dΔn) of a thickness d of the liquid crystal layer and a birefringence index Δn of the liquid crystal material is equal to or more than 236 nm and equal to or less than 252 nm.

3. The liquid crystal display device according to claim 1,
wherein a twist angle of the liquid crystal layer is equal to or more than 830 and equal to or less than 870 when no voltage is applied.

4. The liquid crystal display device according to claim 1,
wherein an average azimuth angle φLCave of the liquid crystal molecule is equal to or more than 150° and equal to or less than 156° when a voltage is applied.

5. The liquid crystal display device according to claim 1,
wherein the liquid crystal material has a ratio (Δn₆₀/Δn₂₀) of a birefringence index Δn₆₀ at 60° C. to a birefringence index Δn₂₀ at 20° C. being equal to or more than 0.84.

6. The liquid crystal display device according to claim 1,
wherein the liquid crystal material has an anisotropy of dielectric constant Δε being equal to or lower than 7.

7. The liquid crystal display device according to claim 1, further comprising:
a polarizer disposed outside the first substrate and/or the second substrate; and
a phase difference layer disposed between the first substrate and the polarizer and/or between the second substrate and the polarizer,
wherein the phase difference layer includes λ/4 plate and a λ/2 plate.

8. The liquid crystal display device according to claim 1,
wherein the liquid crystal display device has a single domain alignment.

9. The liquid crystal display device according to claim 1,
wherein display is performed in a normally black mode.

10. The liquid crystal display device according to claim 1,
wherein one of the first electrode and the second electrode is a pixel electrode provided in each of the plurality of pixels and the other is a common electrode including a plurality of segments each of which is configured to function as a touch sensor electrode, and
the first substrate includes a plurality of touch wiring lines each of which is connected to a corresponding one of a plurality of the touch sensor electrodes.

11. The liquid crystal display device according to claim 1, further comprising:
a light source.
